(19) United States
(12) Patent Application Publication
(10) Pub. No.: US 2002/0156734 A1
(43) Pub. Date: Oct. 24, 2002

(54) System and method for dispensing and receiving cash, and cash dispenser and cash receiving machine for use in the system and method

(75) Inventor: Hidehiko Yamamoto, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/983,515

(22) Filed: Oct. 24, 2001

(30) Foreign Application Priority Data
Apr. 24, 2001 (JP) 2001-126055
Jul. 26, 2001 (JP) 2001-226403

(51) Int. Cl. G06F 17/60

(52) U.S. Cl. 705/43; 705/16

(57) ABSTRACT

A cash dispensing system including a cash dispenser for dispensing cash to clients of the financial institution on their respective requests after the cash dispenser is loaded with cash, which currently belongs to the manager, as prospective permit-to-pay cash; and an account managing section for managing client's accounts and a manager's account of the financial institution; the account managing section being operable to record a credit, of the same amount as an amount of cash to be dispensed to the last-named individual client by the cash dispenser, to the manager's account of the financial institution. The cash dispensing system allows the manager of a retail store to deal with a problem arose during dispensing the prospective permit-to-pay cash without requesting the financial institution or a handling agent. It is possible to prevent a large amount of cash from being left in the retail store thereby enhancing the security.

### BACKGROUND OF THE INVENTION

1. Field of the Invention

The present invention relates to a system and a method for dispensing and/or receiving cash, which are provided by a financial institution such as a bank, and also relates to a cash dispenser preferably used as an ATM (an automatic teller machine), installed at a retail store such as a convenience store, for dispensing cash to individual clients of the financial institution and for receiving cash from the individual clients on request.

2. Description of the Related Art

Conventionally, cash dispensers and ATMs, with which individual clients of a financial institution withdraw cash (at least part of their deposits) and deposit cash, are installed at the head office and branch offices of a financial institution. However, in recent years, the number of cash dispensers and ATMs installed at retail stores and shopping malls, chiefly in convenience stores, is on the rise. With such cash dispensers and ATMs installed at retail stores or the like, it has been customary that individual clients withdraw cash on the way to shopping sites such as retail stores, recording debits to the individual clients' accounts. On the other hand, with conventional cash dispensers and ATMs, demands are made upon the clients' time to drop into the financial institution to withdraw deposits, whereupon the clients may then visit retail stores to purchase commodities. As a result of cash dispensers and ATMs installed at shopping sites, clients are no longer required to spend time and money to stop by the financial institution.

If an individual client does not buy a commodity because the client has insufficient money in hand, the retail store misses the opportunity of a sale. Further, it is a disadvantage to retail stores that clients come to purchase commodities after withdrawing cash from the financial institution.

To overcome the above disadvantage, the retail stores may introduce a settlement system that uses credit or debit cards so that clients enjoy shopping at retail stores even if the clients do not have enough money. In such a settlement system, the retail stores would owe commissions for the sales using credit or debit cards.

As a solution, cash dispensers, as described later with reference to FIG. 17 of the accompanying drawings, are installed at the retail stores so that clients may withdraw cash from their accounts at the financial institution using the cash dispensers. In the presence of such cash dispensers, the retail stores would not owe any commissions and could secure sales opportunities.

FIG. 17 depicts hardware of a general automatic teller machine (ATM) system. In FIG. 17, an ATM system 200 communicably connects a host computer 201 to cash dispensers 203 via a dedicated communications network 202.

The host computer 201 is managed by a financial institution, e.g., a bank, and manages accounts of clients of the financial institution. The cash dispensers 203 are installed at retail stores, in addition to at the head office and branch offices of the financial institution, and dispense cash in response to the requests of individual clients.

When an individual client of the financial institution requests a payment by inputting to a cash dispenser 203 a required (requested) amount of cash and information about the payment request is sent to the host computer 201 via the dedicated communications network 202. Upon receipt of the information, the host computer 201 records a debit, of the same amount as the amount of cash that the client intends to withdraw, and then the cash dispenser 203 dispenses the requested amount of cash.

ATMs also function as cash receiving machines into which an individual client inserts cash to record a credit (deposit) to the client's account with the financial institution.

In the conventional ATM system 200, since cash stored in the cash dispenser 203 (or an ATM) are belonging to a financial institution, or a handling agent, who manages and works with the cash dispensers 203 (or the ATM) under contract with the financial institution, the manager or clerks of the retail store, where the cash dispenser 203 is installed, have no authority to load the cash dispenser 203 (or the ATM) with cash. Furthermore, if a problem arises with the cash dispenser 203 (or the ATM) in transferring bills, the manager or clerks of the retail store have no authority to remove the bill causing the problem.

Therefore, the manager or clerks have to pay a charge the financial institution or the handling agent for working with the cash dispenser 203 or the ATM, including loading cash and guarding against risks, and may incur substantial costs. Further, partly since the manger or clerks have no authority to deal with problems (e.g., transferring bills) arose with the cash dispenser 203 or the ATM, and partly since clients, the manager and clerks all have to wait for (an attendant of) the handling agent assigned to deal with the problem, the clients, the manager and the clerks are greatly inconvenienced by the long period of time required until the cash dispenser 203 or the ATM is repaired.

In a retail store, sales cash obtained by transactions (sales) of a day is stored in a register of a POS (point of sales) terminal. Since there is possibility that stored cash may be stolen, it is not preferable to store more cash than necessary for change. As a solution, the following method is known in the art: a retail store is equipped with a cash receiving machine (of a cash receiving system), as depicted in FIG. 18 of the accompanying drawings, so that the sales cash is deposited in the retail store's account at a financial institution via a security agent by inserting the sales cash into the cash receiving machine.

FIG. 18 of the accompanying drawings is a block diagram of a general cash receiving system. The cash receiving system 400 comprises a host system 401, a recording credit system 402, and a plurality of cash receiving terminals 403 (only one shown for convenience of illustration).

The cash receiving terminal 403 is installed at a retail store or the like, and is communicably connected to the recording credit system 402. The manager of the retail store deposits sales cash into a cash receiving section of the cash receiving terminal 403. In response to the deposit of the sales cash by the manager, the cash receiving terminal 403 sends information about the deposit (e.g., the amount of the deposited cash) to the recording credit system 402.

The recording credit system 402 is managed by a collecting agent, such as the above-mentioned handling agent or the security agent, and issues a request for a remittance to the host system 401 based on the information from the cash receiving terminal 403.

The host system 401 is managed by a financial institution, such as a bank, manages the manager's account (an account of the manager of a retail store) of the financial institution, and is communicably connected to the recording credit system 402. The host system 401 records a credit, of the same amount as the amount of cash inserted into the cash receiving terminal 403 by the manager, to the manager's account of the financial institution based on the information received from the cash receiving terminal 403. There by the cash in the cash receiving terminal 403 installed at the retail store legally belongs to the collecting agent.

Nevertheless, since the cash in the cash receiving terminal 403 legally belongs to the collecting agent, likewise cash in the above-mentioned cash dispensers 203 and ATMs, the manager or clerks of the retail store have no authority to handle the cash in the cash receiving terminal 403.

Accordingly, the retail store incurs substantial costs for the charge of working the cash receiving terminal 403. To repeat, if a problem arises with the cash receiving machine 403 in transferring bills, the clients, the manager and the clerks all have to wait for the collecting agent to solve the problem, which may require a long time to repair the cash receiving machine 403.

In the meantime, since cash that legally belongs to the financial institution or the collecting agent and cannot be at owner's disposal is stored as assets, it is impossible for the financial institution or the collecting agent to effectively turn over the assets left in store in the cash dispenser 203 or the cash receiving terminal 403.

### SUMMARY OF THE INVENTION

With the foregoing problems in view, it is an object of the present invention to provide systems and methods for dispensing and/or receiving cash in which, if a problem arises, the retail store solves that problem without requesting the help of a financial institution or a handling agent, and in which no cash is left in the retail store thereby enhancing security.

Another object of the present invention is to provide a cash dispenser and a cash dispensing/receiving machine, which are used in the above-mentioned systems and methods.

As a first generic feature, there is provided a cash dispensing system comprising: a cash dispenser, installed at a site where a manager manages the cash dispenser under contract with a financial institution, for dispensing cash to clients of the financial institution on their respective requests after the cash dispenser is loaded with cash, which currently belongs to the manager, as prospective permit-to-pay cash; and an account managing section for managing client's accounts and a manager's account of the financial institution; the account managing section being operable, before the cash dispenser dispenses the prospective permit-to-pay cash to the individual client, to record a credit, of the same amount as an amount of cash to be dispensed to the last-named individual client by the cash dispenser, to the manager's account of the financial institution.

As a second generic feature, there is provided a method of dispensing cash to clients from a cash dispenser installed at a site where a manager manages the cash dispenser under contract with a financial institution, the method comprising the steps of:

(a) loading the cash dispenser with cash, which currently belongs to the manager, as prospective permit-to-pay cash; (b) recording a credit, of the same amount as an amount of cash to be dispensed to an individual client of the financial institution by the cash dispenser, to the manager's account of the financial institution using an account managing section, of the financial institution, communicably connected with the cash dispenser; and (c) dispensing the prospective permit-to-pay cash, which is equivalent to the last-named amount of cash, to the last-named individual client.

As a third generic feature, there is provided a cash dispenser, adapted to be installed at a site where a manager manages the cash dispenser under contract with a financial institution, for dispensing cash to clients of the financial institution on their respective requests, wherein: the cash dispenser is loaded with cash, which currently belongs to the manager, as prospective permit-to-pay cash; and upon completion of recording a credit, of the same amount as an amount of cash to be dispensed to an individual client of the financial institution, to the manager's account of the financial institution, the cash dispenser dispenses the prospective permit-to-pay cash, which is equivalent to the last-named amount of cash, to the last-named individual client.

With the foregoing generic features, the cash, of the same amount as an amount of cash to be dispensed to the last-named individual client, belongs to the manager of the site where the cash dispenser is installed before completion of recording a credit, of the same amount as an amount of cash to be dispensed to the last-named individual client, to the manager's account. Upon completion of the recording the credit to the manager's account, the cash, of the same amount as an amount of cash to be dispensed to the last-named individual client, which cash has currently belonged to the manager, becomes to belong to the financial institution.

As a preferable feature, the account managing section may record a debit, of the same amount as the amount of the cash to be dispensed to the last-named individual client, from a source account. Therefore, the cash dispensed to the last-named individual client is withdrawn from the source account.

As another preferable feature, the account managing section may record the credit immediately before the prospective permit-to-pay cash is ejected from the cash dispenser. In this case, the prospective permit-to-pay cash belongs to the manager of the site where the cash dispenser is installed immediately before the prospective permit-to-pay cash is ejected from the cash dispenser.

As a fourth generic feature, there is provided a cash receiving system comprising: a cash receiving machine, installed at a site where a manager manages the cash receiving machine under contract with a financial institution, for receiving cash from clients of the financial institution on their respective requests as prospective belong-to-manager cash; and an account managing section for managing client's accounts and a manager's account of the financial institution; the account managing section being operable, when the cash receiving machine receives the prospective belong-to-manager cash from the individual client, to record a debit, of the same amount as an amount of cash received from the last-named individual client by the cash receiving machine, to the manager's account of the financial institution.

As a fifth generic feature, there is provided a method of receiving cash from clients by a cash receiving machine installed at a site where a manager manages the cash receiving machine under contract with a financial institution, the method comprising the steps of: (a) receiving cash from an individual client of the financial institution by the cash receiving machine as prospective belong-to-manager cash; and (b) recording a debit, of the same amount as an amount of cash received from the last-named individual client, to the manager's account of the financial institution using an account managing section communicably connected with the cash receiving machine.

As a result, as recording a debit, of the same amount as an amount of cash received from the last-named individual client, to the manager's account of the financial institution, the prospective belong-to-manager cash, which the cash receiving machine or the cash dispensing and receiving machine received from the last-named individual client, becomes to belong to the manager of the site where the cash receiving machine or the cash dispensing and receiving machine is installed.

As an additional preferable feature, the account managing section may record a credit, of the same amount as an amount of cash received from the last-named individual client, to a destination account. Therefore, the cash, of the same amount as an amount of cash received from the last-named individual client, is deposited into the destination account.

As still additional preferable feature, the cash receiving system may further comprise a notification section for notifying, if the debit is unsuccessfully recorded to the manager's account, information about a cause of the unsuccessful debit to the last-named individual client. Thereby, it is possible for the last-named individual client to grasp a cause of the unsuccessful debit.

As a sixth generic feature, there is provided a cash dispensing and receiving system comprising: a cash dispensing/receiving machine, installed at a site where a manager manages the cash dispensing/receiving machine under contract with a financial institution, for dispensing cash to clients of the financial institution after the cash dispensing/receiving machine is loaded with cash, which currently belongs to the manager, as prospective permit-to-pay cash and for receiving cash from the clients as prospective belong-to manager cash on their respective requests; and an account managing section for managing clients' accounts of the financial institution; the account managing section being operable, before the cash dispensing/receiving machine dispenses the prospective permit-to-pay cash to the individual client, to record a credit, of the same amount as an amount of cash to be dispensed to the last-named individual client by the cash dispensing/receiving machine, to the manager's account of the financial institution; and the account managing section being operable, when the cash dispensing/receiving machine receives the prospective belong-to-manager cash from the last-named individual client, to record a debit, of the same amount as an amount of cash received from the last-named individual client by the cash dispensing/receiving machine, to the manager's account of the financial institution.

When the a cash dispensing/receiving machine dispenses cash to the last-named individual client, the prospective permit-to-pay cash, of the same amount as the amount of cash to be dispensed to the last-named client, belongs to the manager of a site where the a cash dispensing/receiving machine is installed before completion of the recording the credit of the same amount as the amount of the prospective permit-to-pay cash to the manager's account. Upon completion of the recoding the credit, the prospective permit-to-pay cash, which has currently belonged to the manager, becomes to belong to the financial institution. Further, upon completion of the recording of the debit, of the same amount as the amount of the prospective belong-to-manager cash received from the last-named individual client, to the manager's account, the prospective belong-to-manager cash becomes to belong to the manager.

With the cash dispensing system, the method of dispensing cash, the cash dispenser, the cash receiving system, the method of receiving cash and the cash dispensing and receiving system, it is possible to guarantee the following advantageous results:

(1) Since the cash dispenser is loaded with cash, which currently belongs to the manager of a site where the cash dispenser is installed, as prospective permit-to-pay cash, it is possible to the manager to perform maintenance operations thereby improving the convenience level to the clients and the manager, and reducing the cost for working the cash dispenser.

(2) Since cash stored in the cash dispenser belongs to the manager, it is possible for the manager to collect the cash in the cash dispenser as required (e.g., at night or during holidays). Further, it is possible for the cash in the cash dispenser to avoid the possibility of being stolen because a large amount of cash is prevented from being left in the cash dispenser in the nighttime. As a result, the security of the cash dispenser is enhanced.

(3) Partly since a credit, of the same amount as an amount of cash to be dispensed to the client from the cash dispenser, is recorded to the manager's account before the cash dispenser dispenses the prospective permit-to-pay cash, and partly since the prospective permit-to-pay cash in the cash dispenser comes into the property of the financial institution, the cash dispenser dispenses the prospective permit-to-pay cash free from legal defects.

(4) Since the account managing section records a credit to the manager's account immediately before the cash dispenser dispenses cash, the prospective permit-to-pay cash in the cash dispenser belongs to the manager immediately before the cash dispenser dispenses the prospective permit-to-pay cash. If a problem arises during transferring cash in the cash dispenser, this allows the manager to deal with the problem thereby improving the convenience level for the clients and the manager.

(5) Since the recorded credit is canceled if a problem arises with the cash dispenser during dispensing the prospective permit-to-pay cash, the prospective permit-to-pay cash, which has come into the property of the financial institution by the recording the credit, is returned to belong to the manager. Therefore, if a problem arises during transferring the prospective permit-to-pay cash in the cash dispenser, the manager has authority to deal with the problem thereby improving the convenience level for the clients and the manager.

(6) Since, if a problem arises with the cash dispenser during dispensing the prospective permit-to-pay cash to the last-named individual client, the contents of the problem is notified to the last-named individual client. As a result, it is possible for the clients to grasp the contents of problems thereby improving service to the clients.

(7) Even if the prospective permit-to-pay cash includes invalid cash, the discrimination of the prospective permit-to-pay cash eliminates the invalid prospective permit-to-pay cash from being dispensed to the last-named individual clients by removing the discriminated invalid prospective permit-to-pay cash before the dispensation thereby improving the reliability to the cash dispenser.

(8) It is possible to prevent invalid cash from being stored in the cash dispenser by discriminating the prospective permit-to-pay cash at the time when the cash dispenser is loaded with the prospective permit-to-pay cash. This results in storing only valid prospective permit-to-pay cash in the cash dispenser thereby improving the reliability to the cash dispenser.

(9) Since the cash dispenser dispenses the prospective permit-to-pay cash to the last-named individual client by a predetermined unit amount, it is possible to exactly recognize the state of dispensing the prospective permit-to-pay cash, even if a problem arises during dispensing the prospective permit-to-pay cash, thereby improving the convenience in working the cash dispenser.

(10) As receiving the prospective belong-to-manager cash from the last-named individual client, the account managing section records a debit, of the same amount as an amount of the prospective belong-to-manager cash received from the last-named individual client, to an account of manager that manages a site where the cash receiving machine. Since this makes the prospective belong-to-manager cash becomes to belong to the manager, it is possible for the manager to perform maintenance operations with respect to the cash in the cash receiving machine or the cash dispensing/receiving machine thereby improving the convenience of the clients and the manager. Additionally, it is possible to reduce the cost of working the cash receiving machine or the cash dispensing/receiving machine, and since the manager can collect the cash in the cash receiving machine or the cash dispensing/receiving machine as required (e.g., in the nighttime or in holidays), it is possible to obviate the possibility of being stolen because a large amount of cash is prevented from being left in the cash receiving machine or the cash dispensing/receiving machine in the nighttime. As a result, the security of the cash receiving machine or the cash dispensing/receiving machine is enhanced.

(11) If a credit is unsuccessfully recorded to a destination account, information about a cause of the unsuccessful credit is notified to the last-named individual client. Therefore the last-named individual client can grasp the cause of the unsuccessful credit, that is, the service to the clients can be improved.

(12) If a credit is unsuccessfully recorded to a destination account, the recorded credit to a destination account and the recorded debit to the manager's account are canceled. As a result, since the prospective belong-to-manager cash in the cash receiving machine or the cash dispensing/receiving machine becomes back to belong to the client, the manager deals with a problem arose during transferring the prospective belong-to-manager with permission of the last named individual client, and the convenience of the clients and the manager can be improved.

(13) It is possible to prevent invalid cash from being stored in the cash receiving machine or the cash dispensing/receiving machine by discriminating the prospective belong-to-manager cash as receiving the prospective belong-to-manager cash from the last-named individual client. This results in receiving only valid prospective belong-to-manager cash in the cash receiving machine or the cash dispensing/receiving machine thereby improving the reliability to the cash dispenser.

Other objects and further features of the present invention will be apparent from the following detailed description when read in conjunction with the accompanying drawings.

### BRIEF DESCRIPTION OF THE DRAWINGS

FIG. 1 is a block diagram schematically showing a cash dispensing/receiving system (a cash dispensing system) according to a first embodiment of the present invention;

FIG. 2 is a perspective view showing a cash dispenser used in the cash dispensing/receiving system of FIG. 1;

FIG. 3 is a flow diagram illustrating a succession of procedural steps performed by a relay center when the cash dispenser dispenses cash in the cash dispensing/receiving system of FIG. 1;

FIG. 4 is a flow diagram illustrating the succession of procedural steps performed by a relay center when a problem arises with the cash dispenser during dispensing cash in the cash dispensing/receiving system of FIG. 1;

FIG. 5 is a flow diagram illustrating a succession of procedural steps of dispensing cash performed in the cash dispenser of FIG. 2;

FIG. 6 is a flow diagram similar to FIG. 3, but illustrating a succession of procedural steps performed by a relay center when dispensing cash in the cash dispensing/receiving system according to a second embodiment;

FIG. 7 is a flow diagram similar to FIG. 5, but illustrating a succession of procedural steps of dispensing cash performed in the cash dispenser according to the second embodiment;

FIG. 8 is a flow diagram similar to FIG. 5, but illustrating a succession of procedural steps of dispensing cash performed in the cash dispenser according to a third embodiment;

FIG. 9 is a block diagram schematically showing a first modification of the cash dispenser of the cash dispensing/receiving systems according to the first through third embodiments;

FIG. 10 is a flow diagram illustrating a succession of procedural steps of dispensing cash in the cash dispenser of FIG. 9;

FIG. 11 is a block diagram similar to FIG. 9, but schematically showing a second modification of the cash dispenser of the cash dispensing/receiving systems according to the first through third embodiments;

FIG. 12 is a flow diagram illustrating a succession of procedural steps of loading cash into the cash dispenser of FIG. 11;

FIG. 13 is a block diagram similar to FIG. 1, but schematically showing a cash dispensing/receiving system (a cash receiving system, a cash dispensing/receiving system) according to a fourth embodiment of the present invention;

FIG. 14 is a perspective view similar to FIG. 2, but showing a cash receiving machine (a cash dispensing/receiving machine) in the cash dispensing/receiving system of FIG. 13;

FIG. 15 is a is a flow diagram illustrating a succession of procedural steps performed by a relay center when receiving cash from a client in the cash dispensing/receiving system of FIG. 13;

FIG. 16 is a flow diagram illustrating a succession of procedural steps of receiving cash from a client, which steps are performed in the cash dispenser of FIG. 13;

FIG. 17 is a diagram showing hardware of a general automatic teller machine (ATM) system; and

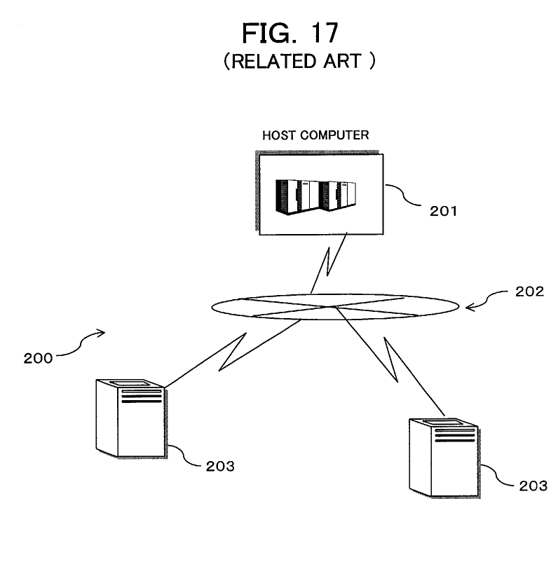

FIG. 18 is a block diagram schematically showing a general cash receiving system.

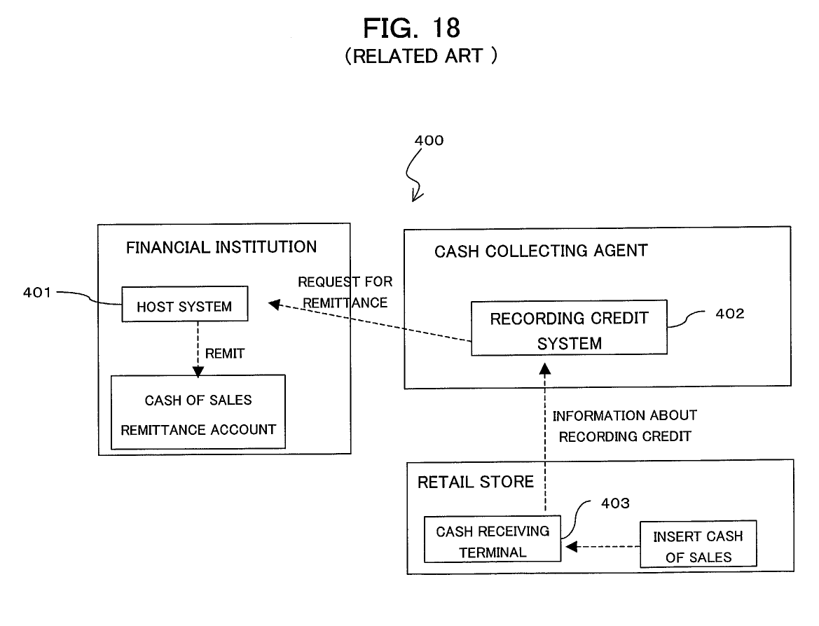

### DESCRIPTION OF THE PREFERRED EMBODIMENTS

Various preferred embodiments of the present invention will now be described with reference to the accompanying drawings.

(A) First Embodiment:

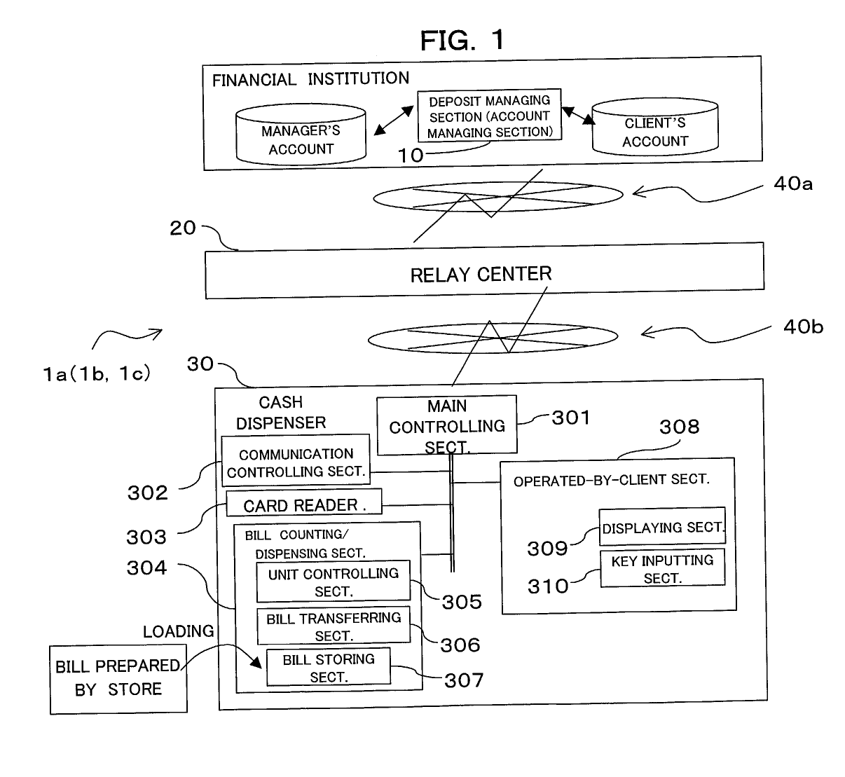

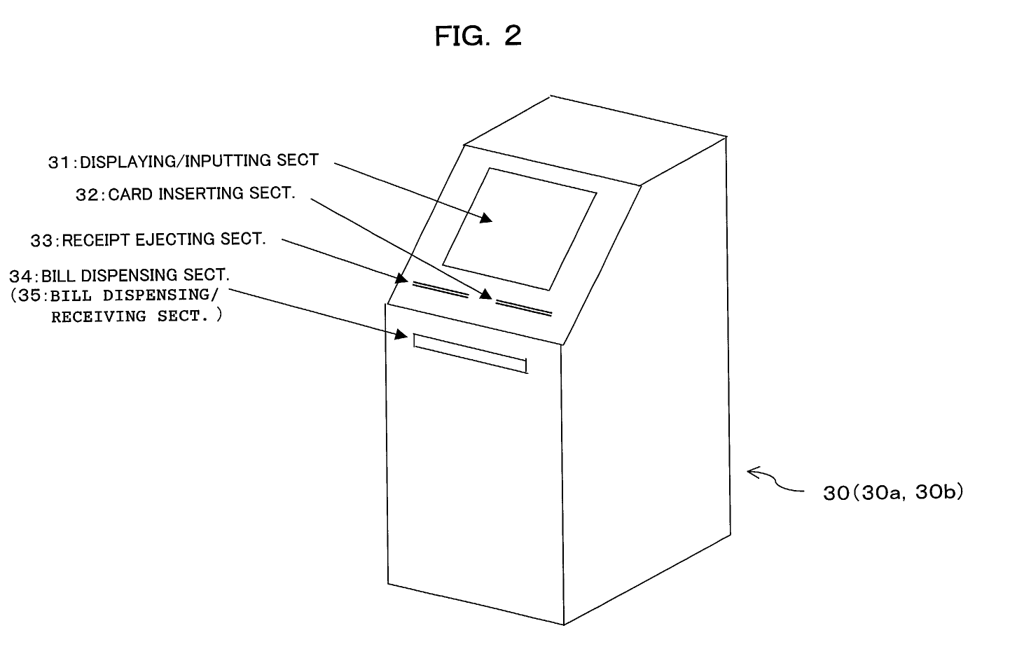

FIG. 1 shows a cash dispensing/receiving system (a cash dispensing system) according to a first embodiment of the present invention; and FIG.2 shows a perspective view of a cash dispenser used in the cash dispensing/receiving system of FIG. 1.

As shown in FIG. 1, the cash dispensing/receiving system 1a of the first embodiment comprises a deposit managing section (an account managing section, a financial institution center) 10, a relay center (payment transaction center) 20, a cash dispenser 30, and communication networks 40a and 40b. The deposit managing section 10 is communicably connected to the cash dispenser 30 via the relay center 20 and the communication networks 40a and 40b.

The cash dispenser 30 is installed in a retail store under contract with a financial institution, and, responding to a request from a client, dispenses cash (permit-to-pay cash), of the same amount as an amount of cash withdrawn from a payment account (a source account, a client's account in the illustrated embodiment), to the client. In this embodiment, it is assumed that the permit-to-pay cash is one or more bills.

Hardware of the cash dispenser 30 will now be described with reference to FIG. 2. The cash dispenser 30 is equipped with a displaying/inputting section 31, a card inserting section 32, a receipt ejecting section 33, and a bill dispensing section 34.

The displaying/inputting section 31 is in the form of a touch panel or the like, and displays a keyboard and a button in combination with information for clients. On the basis of the information shown on the displaying/inputting section 31, clients execute various inputting operations; for example, the clients input amounts of cash required, and a password set for an individual client's account.

In the illustrated embodiment, the displaying/inputting section 31 of a touch panel performs both displaying of information and inputting, however the displaying/inputting section 31 should by no means be limited to a touch panel. As an alternative, the cash dispenser 30 may be equipped with a display section (e.g., a monitor) for displaying various kinds of information and an inputting section (e.g., a keyboard) for inputting operations, respectively.

A medium, such as a cash card or a credit card for specifying an account of a client of a financial institution, is inserted into the card inserting section 32. Such a medium is exemplified by a magnetic card and an IC card (hereinafter simply called a “card”). The contents of a card inserted via the card inserting section are read by a later-described card reader 303 (see FIG. 1). The card inserting section 32 also serves to eject an inserted card after completion of a corresponding payment transaction.

The bill dispensing section 34 dispenses bills (cash) transferred thereto by a later-described bill transferring section 306 (see FIG. 1) out of the cash dispenser 30. The bill dispensing section 34 has a non-illustrated cover plate, and dispenses transferred bills by opening the cover plate so that clients can obtain the bills. The receipt ejecting section 33 rejects receipts on which contents of respective transactions are printed.

A bill storing section 307 stores bills (cash) belonging to a manager of a site where the cash dispenser 30 is installed (hereinafter simply called the “manager”) as prospective permit-to-pay cash by fitting a non-illustrated case that contains the permit-to-pay cash to the bill storing section 307.

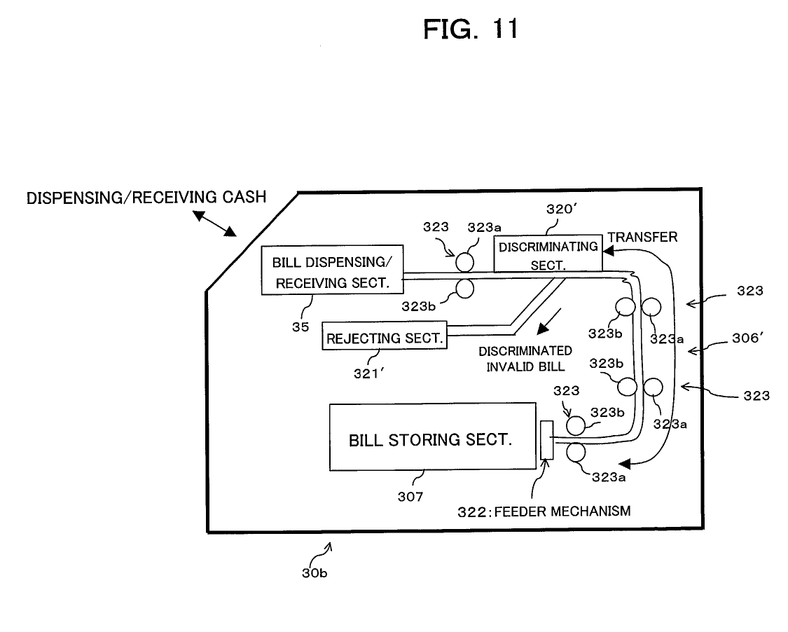

The manner of loading the permit-to-pay cash into the cash dispenser 30 should by no means be limited to the above-mentioned manner. Alternatively, the cash dispenser 30 may be loaded with bills by inserting bills from a bill loading section (not shown in FIG. 2; e.g., a bill dispensing/receiving section 35 of FIG. 11) by sheet or by the predetermined number of sheets, whereupon the inserted bills are transferred to the bill storing section 307 by the bill transferring section 306.

The functional configuration of the cash dispenser 30 will now be described. As shown in FIG. 1, the cash dispenser 30 comprises a main controlling section 301, a communication controlling section 302, the card reader 303, a bill counting/dispensing section 304, and an operated-by-client section 308.

The main controlling section 301 overall controls the communication controlling section 302, the card reader 303, the bill counting/dispensing section 304, and the operated-by-client section 308 based on instructions from the relay center 20. The main controlling section 301 is, for example, realized by a CPU (central processing unit) in a computer system.

The communication controlling center 302, which is, for example, realized by a LAN (local area network) card, communicates with the relay center 20 to send and receive various information. The card reader 303 reads contents registered on a clients' cash cards inserted into the card inserting section 32.

The bill counting/dispensing section 304 stores and dispenses the permit-to-pay cash, and includes a unit controlling section 305, the bill transferring section 306, and the bill storing section 307. The bill storing section 307 stores permit-to-pay cash that has been loaded into the cash dispenser 30 by the manager. The bill transferring section 306 transfers bills to a destination in the cash dispenser 30. Specifically, the bill transferring section 306 transfers bills (the permit-to-pay cash) from the bill storing section 307 to the bill dispensing section 34 when dispensing the permit-to-pay cash to a client. The unit controlling section 305 controls the bill transferring section 306 and bill storing section 307.

The operated-by-client section 308 is identical with the displaying/inputting section 31 of FIG. 2, and is used when a client performs inputting or other operations. The operated-by-client section 308 includes a displaying section 309 and a key inputting section 310. The displaying section 309 displays various kinds of information for clients so that clients may refer to the information when making transactions. The key input section 310 is used when a client selects and inputs items in accordance with the information on the displaying section 309.

If a problem arises with the cash dispenser 30 when dispensing the permit-to-pay cash to a client, the contents of the problems are notified to the client by displaying the contents on the displaying section 31, narrating the contents from a non-illustrated speaker, or issuing a receipt on which the contents are printed from the receipt ejecting section 33. The displaying section 31, the speaker, and the receipt ejecting section 33 respectively serve to function as notifying sections to notifyi the details (contents) of a problem to an individual client.

In the illustrated cash dispensing system la, a client may be responsible for an unsuccessful dispensation of cash to the client because of a balance shortage in the client's account. On the other hand, the manager may be responsible for the unsuccessful dispensation due to a problem that occurred during recording a credit to the manager's account. Therefore the reason for the impossibility of the dispensation is displayed on the displaying/inputting section 31 so that the client is prevented from being confused.

One or more financial institutions manage the deposit managing section 10, which manages accounts (deposits of clients or the manager) in the financial institutions. The deposit managing section 10 records credits and debits to the accounts.

Before the cash dispenser 30 dispenses the permit-to-pay cash to a client, the deposit managing section 10 records a credit, of the same amount as the amount of cash to be dispensed to the client, to the manager's account (hereinafter also called the store's account) of the financial institution.

The store's account may be possessed by the manager, or may be possessed by the retail store where the cash dispenser 30 is installed.

In the illustrated embodiment, the cash dispenser 30 is loaded with cash, which currently belongs to the manager, as the prospective permit-to-pay cash. In general practice, when a client operates the cash dispenser 30 to withdraw a desired amount of cash from the deposit in a client's account of a financial institution, the cash dispenser 30 has to dispense cash belonging to the financial institution to the client.

At that time, the deposit managing section 10 records, in the store's account, the credit of the same amount as the amount of bills to be dispensed to the client, which bills are loaded into the cash dispenser 30. Since a part of the permit-to-pay cash, which part is the same amount as the amount of cash to be dispensed to the client, currently belongs to the manager comes into the property of the financial institution as a result of the recording, the part of the permit-to-pay cash comes into the property of the financial institution.

Since recording the credit is identical with transferring the part of the permit-to-pay cash in the cash dispenser 30 to the store's account in the financial institution, the total amount of assets owned by the manager is unchanged. With respect to the financial institution, since recording the credit is identical with moving cash, of an amount to be dispensed to the client, to the cash dispenser 30, the total amount of assets owned by the financial institution does not change.

Further, upon receipt of a request for dispensing cash from the client operating the cash dispenser 30, the deposit managing section 10 records a debit, of the same amount as the amount of cash requested to be dispensed to the client, to the client's account.

Strictly speaking, at the time of completion of recording the debit to the client's account, the client possesses permit-to-pay cash, of the same amount of that to be dispensed to the client, in the cash dispenser 30. However, since the financial institution still has a liability to pass the cash over to the client, it is assumed that the cash, which is in the cash dispenser 30 and which actually belongs to the client, belongs to the financial institution for convenience.

If a problem arises with the cash dispenser 30 while the permit-to-pay cash is being dispensed to the client, the deposit managing section 10 cancels the recording of the credit to the store's account and the recording of the debit to the client's account. As a result, since the manager possesses all permit-to-pay cash in the cash dispenser 30 again, the manager has the authority to deal with the problem, such as by removing a jammed bill if a problem in transferring a bill to the bill dispensing section 34 arises in the bill transferring section 306.

As an additional function, if the requested amount of cash is not successfully dispensed, the deposit managing section 10 notifies the cash dispenser 30 of the reason for the failure.

The relay center 20 communicably connects the deposit managing section 10 with the cash dispenser 30, and causes the deposit managing section 10 to execute the above-mentioned various transactions in accordance with various transactions performed using the cash dispenser 30. Specifically, the relay center 20 receives telegrams on the transactions whereupon it performs relay processes by keeping contact with the deposit managing section 10.

The relay center 20 is communicably connected to the deposit managing section 10 via the communication network 40a, and is communicably connected to the cash dispenser 30 via communication network 40b.

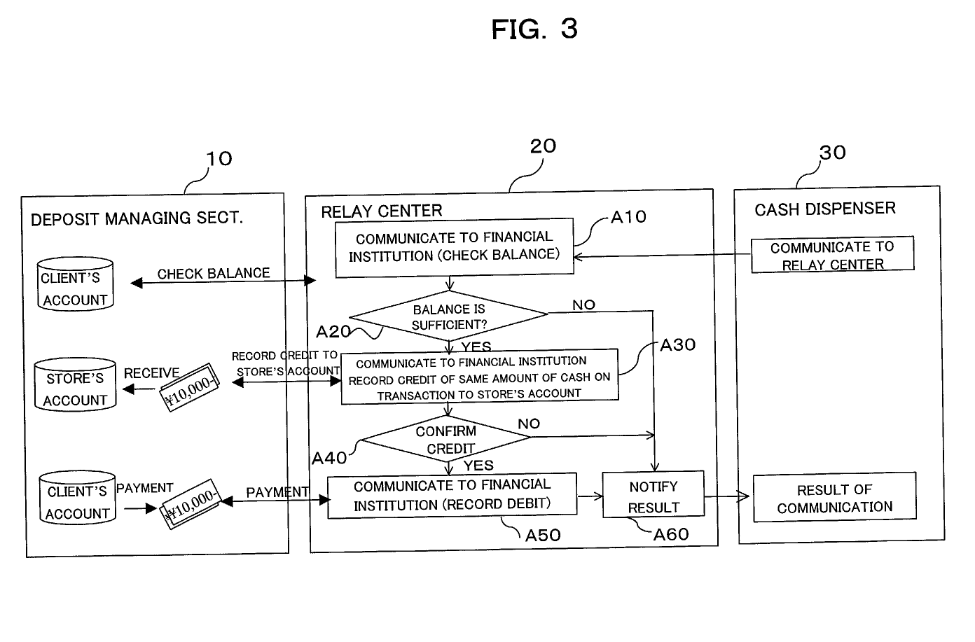

A succession of procedural steps (Steps A10 to A60) performed by the relay center 20 in the cash dispensing/receiving system 1a will now be described with reference to FIG. 3.

When a client requests payment of cash by inputting information of an amount of cash requested to be paid and a password to the cash dispenser 30, the cash dispenser 30 communicates with the relay center 20 to send the input information to the relay center 20. Upon receipt of the information, the relay center 20 communicates with the deposit managing section 10 of the financial institution to request checking of the balance of the client's account (Step A10), and, responding to the request, the deposit managing section 10 checks the balance of the client's account and notifies the relay center 20 of the result of the check.

On the basis of the result of the checking from the deposit managing section 10, the relay center 20 determines whether or not the balance of the client's account becomes minus when cash of an amount requested by the client is withdrawn (Step A20). If the balance of the client's account is insufficient (No route in Step A20), the relay center 20 notifies the cash dispenser 30 of the result of the determination (Step A60; in this case, the impossibility of payment).

Conversely, when the balance of the client's account is sufficient (Yes route in Step A20), the relay center 20 communicates with the deposit managing section 10 so as to cause the deposit managing section 10 to record a credit, of the same amount as the amount of cash requested by the client (as the amount of cash on transaction), to the store's account (Step A30). As a result of recording the credit, the partial permit-to-pay bill, which is possessed by the manager and which is loaded in the cash dispenser 30, of the same amount as the amount of cash requested for payment by the client comes into the property of the financial institution.

The relay center 20 confirms whether or not the credit is successfully recorded to the store's account (Step A40), whereupon, if the recording fails (No route in Step A40), the procedural steps are followed by Step A60 to notify the cash dispenser 30 that the payment to the client cannot be executed because of the unsuccessful recording of the credit.

If the credit is successfully recorded to the store's account (Yes route in Step A40), the relay center 20 causes the deposit managing section 10 to record a debit of the same amount as the amount of the credit recorded to the client's account (Step A50), whereupon the procedural steps are followed by Step A60 to notify the cash dispenser 30 that the payment to the client can be executed. Responsive to the notification, the cash dispenser 30 dispenses one or more bills of the amount requested from the bill dispensing section 34.

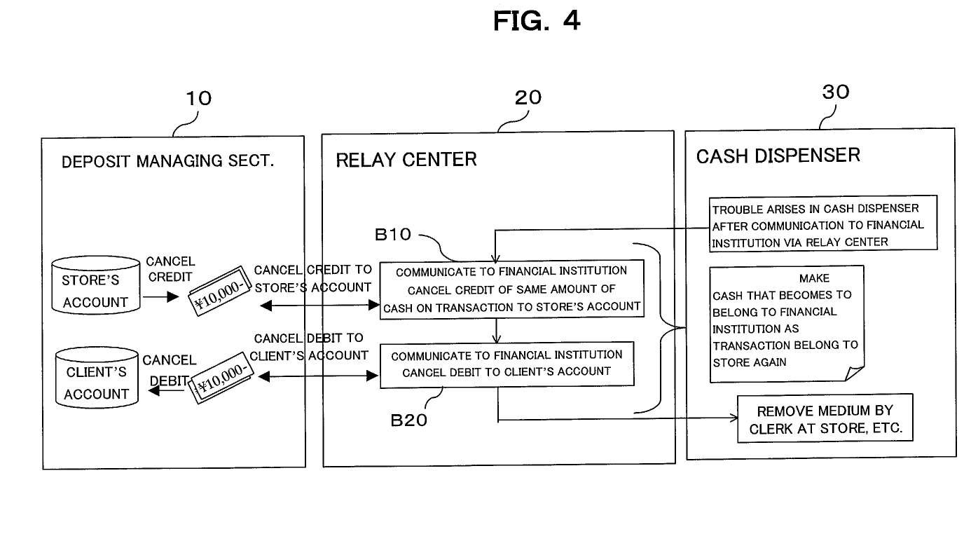

Here, a succession of procedural steps (Steps B10 to B20) performed by a relay center 20 when a problem arises with the cash dispenser 30 when dispensing cash in the cash dispensing/receiving system 1a will now be described with reference to FIG. 4.

If, after the cash dispenser 30 communicates with the deposit managing section 10 via the relay center 20, a problem arises with the cash dispenser 30, such as a problem in transferring bills to the bill dispensing section 34 by the bill transferring section 306 or a shortage of bills stored in the bill storing section 307, the cash dispenser 30 notifies the relay center 20 of the occurrence of the problem. Responding to the notification, the relay center 20 causes the deposit managing center 10 to cancel the recorded credit to the store's account (Step B10) and causes the deposit managing section 10 to cancel the recorded debit to the client's account (Step B20).

The entire permit-to-pay cash, part of which has come into the property of the financial institution at Step A30, in the cash dispenser 30 becomes to belong to the manager by canceling the credit recorded to the store's account. Therefore, the manager has the authority to deal with the bills in the cash dispenser 30; the manager or an alternative to the manager can operate the cash dispenser 30 and can carry out a maintenance operation, such as removing a jammed bill in the cash dispenser 30.

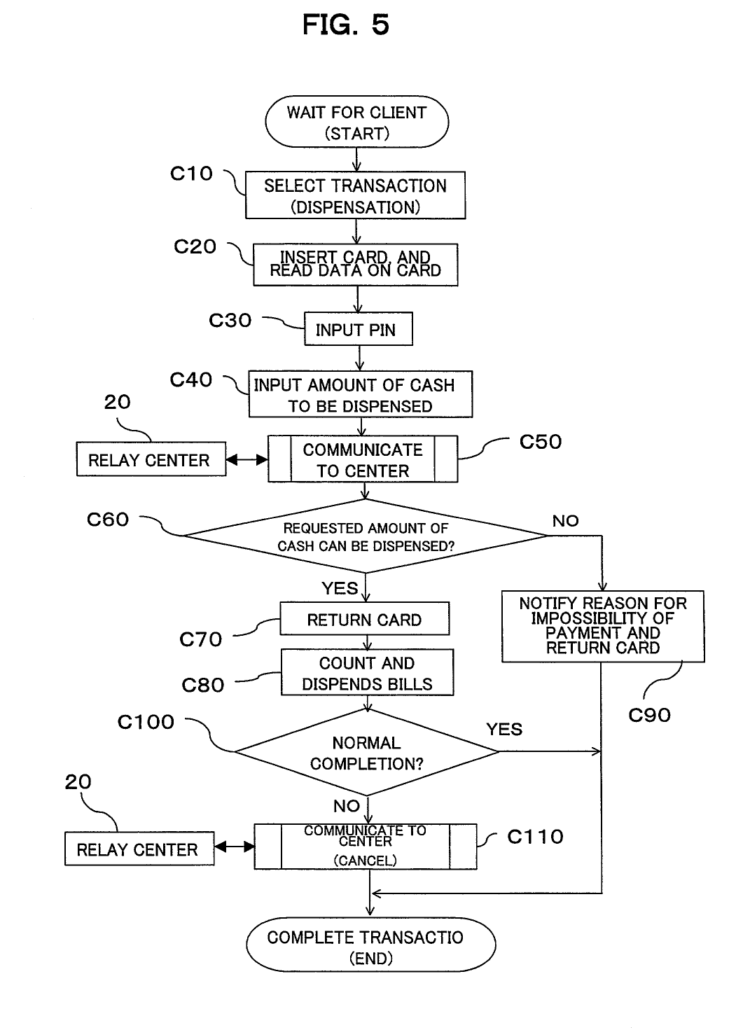

A succession of procedural steps (Steps C10 to C110) of dispensing cash performed in the cash dispenser 30 will now be described with reference to FIG. 5.

When clients select payment cash on the displaying/inputting section 31 of the cash dispenser 30 (Step C10) and insert a client card into the card inserting section 32, the card reader 303 reads information (e.g., an account number) registered on the card (Step C20).

The client inputs the personal identification number (hereinafter called the “PIN”) (Step C30) and successively an amount of cash that the client wishes to withdraw (Step C40) using the displaying/inputting section 31 in accordance with instructions displayed on the displaying/inputting section 31.

The cash dispenser 30 communicates with the relay center 20 to send a telegram of a payment request (Step C50) along with the information (the number of the client's account, the PIN, and the amount of cash requested for payment) obtained in Steps C20 to C40.

The cash dispenser 30 refers to the information sent from the relay center 20 (see Step A60 in FIG. 3) and determines whether or not the requested amount of cash can be paid to the client (Step C60). If the cash cannot be paid (No route in Step C60), the reason is notified to the client on the displaying/inputting section 31, via a non-illustrated speaker or the like. Subsequently, the inserted card is returned to the client (Step C90) to complete the process.

On the other hand, if the requested amount of cash can be paid to the client (Yes route in Step C60), the cash dispenser 30 returns the inserted card to the client (Step C70), counts bills in the bill storing section 307 until the amount of the counted bills reaches the requested amount, transfers the counted bills to the bill dispensing section 34 via the bill transferring section 306, and finally dispenses the bills from the bill dispensing section 34 (Step C80). The client then receives the bills dispensed from the bill dispensing section 34.

The cash dispenser 30 determines whether or not the cash despensed to the client has been normally completed (Step C100). For example, the cash dispenser 30 checks whether or not a problem, such as a transferring problem in the bill transferring section 306, has arisen. When no problem arises and the dispensation is normally completed (Yes route in Step C100), the cash dispenser 30 completes the process.

If the compensation is not performed (No route in Step C100) because of a proble, arising, the cash dispenser 30 communicates to the relay center 20 to notify the relay center 20 that the dispensation has not been performed (Step C110). Upon receipt of the notification, the relay center 20 causes the deposit managing section 10 to cancel the recorded credit to the store's account and the recorded debit to the client's account (See Steps B10 and B20 in FIG. 4). Thereby all bills in the cash dispenser 30 belong to the manager again so that the manager or an alternative to the manager has the authority to remove a jammed bill in the cash dispenser 30 or to perform another operation to solve the problem.

In the cash dispensing/receiving system la of the first embodiment, since the cash dispenser 30 is loaded with bills that currently belong to the manager as permit-to-pay cash, it is possible for the manager (or an alternative to the manager; a clerk of the retail store) to perform maintenance operations for the cash dispenser 30.

For example, when the bills in the cash dispenser 30 run short, the manager can load bills into the cash dispenser 30. As a result, there is no requirement to request the financial institution or an agent acting on behalf of a financial institution under contract or the like to load bills and to wait for the financial institution and the agent to load bills. Further, it is possible to improve the service to the clients and the convenience level for both the clients and the manager. Since the manager minimizes the requests for processes to the financial institution or the agent, it is possible to reduce the cost (service charge) for working the cash dispenser 30, which cost is paid to the financial institution or the agent.

Since the bills in the cash dispenser 30 belong to the manager, it is possible for the manager to retrieve the cash in the dispenser 30 as required, such as at night or during holidays. Thereby, since the manager prevents a large amount of cash from being left in the retail store (the cash dispenser 30) at night, it is possible to avoid having the bills in the cash dispenser 30 stolen, thereby enhancing security in the retail store.

Furthermore, the bills in the cash dispenser 30 are at the manager's disposal because the bills belonging to the manager. For example, the manager has authority to retrieve the bills from the cash dispenser 30 to pay the bills to a business connection, and as a result, the convenience level for the manager is improved.

Partly because the deposit managing section 10 records the credit, of the same amount as an amount of cash to be paid to the client, to the store's account before the requested amount of cash is dispensed to the client, and partly because cash, of the same amount as the requested amount of cash, in the cash dispenser 30 comes into the property of the financial institution, dispensing of cash to the client is executed free from legal defects.

In the cash receiving/dispending system 1a, if a problem arises with the cash dispenser 30 while dispensing cash to the client, partly since the deposit managing section 10 cancels recording the credit to the store's account, and partly since all bills in the cash dispenser are returned to the property of the manager, the manager has the authority to solve the problem with the cash dispenser 30 and the convenience level can be improved.

As a result, since, if a problem in transferring bills to the bill dispensing section 34 or the like arises while the prospective permit-to-pay cash is being dispensed to the customer in the cash dispenser 30, there is no requirement to request the financial agent or an agent as an acting financial institution under the contract to solve the problem or to wait for the financial institution or the agent to arrive at the retail store, it is possible to improve the service to the clients and the convenience of the clients and the manager. In addition, as the manager minimizes the requests for processes to the financial institution or the agent, it is possible to reduce the cost (service charge) for working the cash dispenser 30, which cost is paid to the financial institution or the agent.

Since, as a problem arises, the contents of the problems are notified to a client by the display/inputting section 31 or a non-illustrated speaker, it is possible to improve the service to clients.

Meanwhile, partly since the cash stored in the cash dispenser 30 belongs to the manager, and partly since there is no requirement for the financial institution to stock resources (bills) that are not working, it is possible for the financial institution to effectively turn its assets over.

(B) Second Embodiment:

A cash dispensing/receiving system 1b according to a second embodiment is identical in hardware with the cash dispensing/receiving system 1a of FIG. 1. In the cash dispensing/receiving system 1b, the deposit managing section (the account managing section) 10 records a credit to the store's account of the financial institution immediately before the prospective permit-to-pay cash is dispensed from the cash dispenser 30, as the different point from the cash dispensing/receiving system 1a of the first embodiment.

In the second embodiment, the deposit managing section 10 records a credit to the store's account immediately before the cash dispenser 30 dispenses bills from the bill dispensing section 34-more specifically, immediately before the cover plate of the bill dispensing section 34 opens after transferring of the bills to the bill dispensing section 34. Namely, the deposit managing section 10 records the credit, of the same amount as an amount of cash to be dispensed to the clients, to the store's account and records a debit to the client's account after there is no possibility of a problem arising in transferring bills to the bill dispensing section 34.

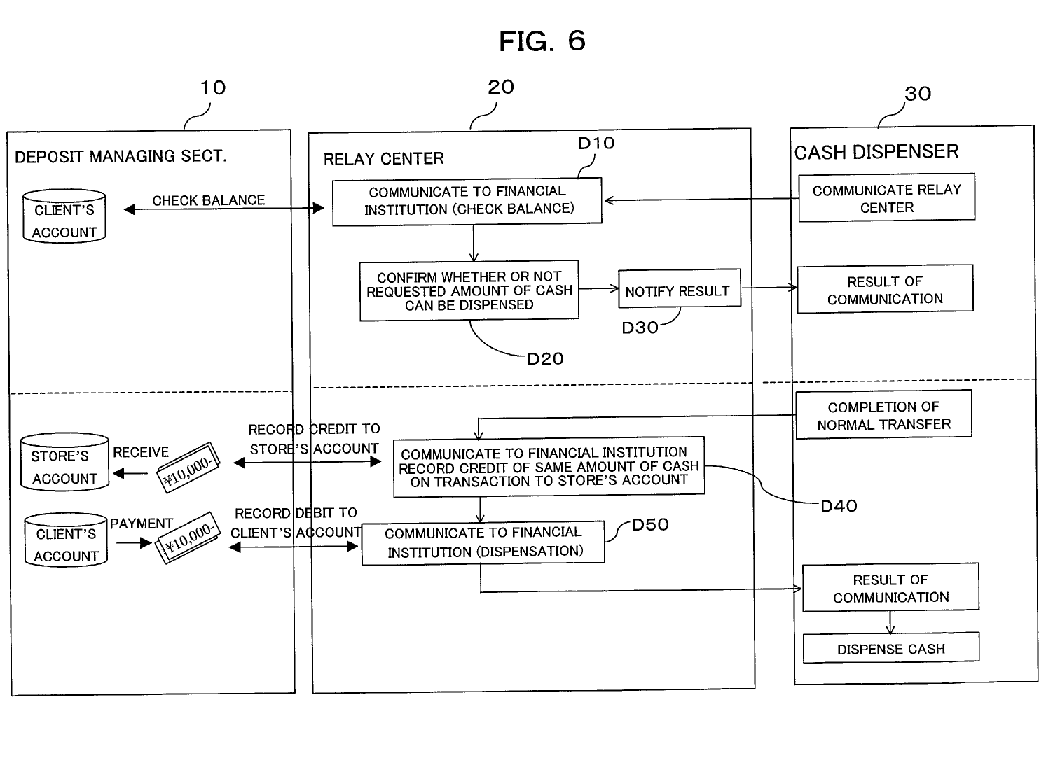

A succession of procedural steps (Steps D10 to D50) performed by the relay center 20 as dispensing cash in the cash dispensing/receiving system 1b will now be described with reference to a flow diagram FIG. 6.

When a client inputs information, such as an amount of cash that the client wishes to be paid and a password, using the cash dispenser 30, the cash dispenser 30 communicates to the relay center 20 to send the input-by-client information. Upon receipt of the input-by-user information, the relay center 20 communicates to the deposit managing section 10 so as to request the deposit managing section to check the balance of the client's account (Step D10). The deposit managing section 10 checks the balance of the clients account, whereupon the deposit managing section 10 notifies the relay center 20 of the result of the check.

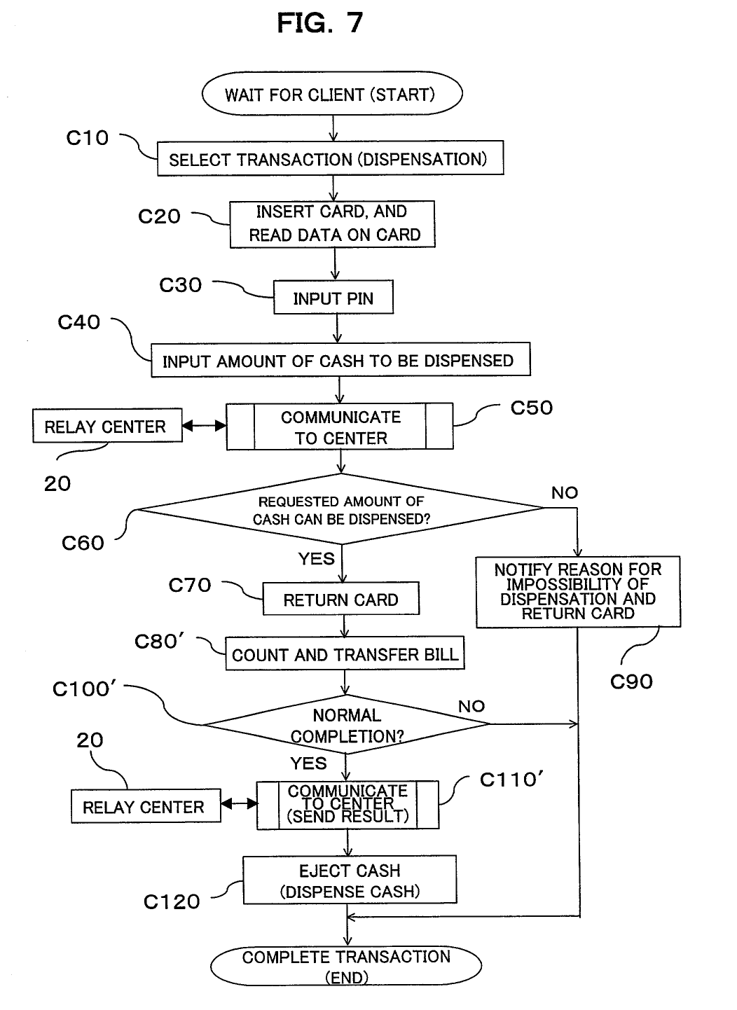

On the basis of the result notified by the deposit managing section 10, the relay center 20 determines whether or not the client's account is sufficient to withdraw the requested amount of cash, in other words, whether or not the amount of cash requested from the client can be paid from the client's account (Step D20). After that, the relay center 20 notifies the cash dispenser 30 of the result (Step D30). Responding to a result that the requested amount of cash can be paid to the client, the cash dispenser 30 counts the bills stored in the bill storing section 307 until the amount of the counted bills reaches the requested amount, and transfers the counted bills to the bill dispensing section 34 using the bill transferring section 306. On the other hand, if the cash dispenser receives a result that the requested amount of cash cannot be dispensed from the clients account (that is, the balance of the client's account is insufficient), the cash dispenser 30 performs the process of Step C90 in FIG. 7 identical with step C90 in FIG. 5.

Since the cash in the cash dispenser 30 belongs to the manager while cash to be dispensed to the client is transferred to the bill dispensing section 34 by the bill transferring section 306, the manager has authority to deal with a problem that arises during transferring cash.

When the bill transferring section 306 transfers bills that are to be dispensed to the bill dispensing section 34 without a problem arising with the cash dispensing/receiving system 1b, the cash dispenser 30 communicates to the relay center 20 to notify the relay center 20 of completion of normal transferring immediately before the transferred cash is dispensed to the client (for example, the cover plate of the bill dispensing section 34 opens so that the client receives the cash). Upon receipt of the notification, the relay center 20 causes the deposit managing section 10 to record a credit, of the same amount as the amount of the cash to be dispensed to the client, to the client's account (Step D40). After recording the credit, permit-to-pay cash, of the same amount as the amount of the cash of the recorded credit, in the cash dispenser 30 comes into the property of the financial institution.

After the relay center 20 causes the deposit managing section 10 to record a debit, of the same amount of the recorded credit, to the client's account (Step D50), the relay center 20 notifies the cash dispenser 30 that the requested amount of cash can be paid to the client. Upon receipt of the notification, the cash dispenser 30 dispenses the transferred cash from the bill dispensing section 34 so that the client receives the bill.

Flow diagram FIG. 7 illustrates a succession of procedural steps (Steps C10 to C70, C80′, C90, C100′, C110′ C120) of dispensing cash performed in the cash dispenser 30.

The process of flow diagram FIG. 7 has Steps C80′, C100′, and C110′ as respective substitutions for Steps C80, C100, and C110 of FIG. 5 performed in the cash dispensing/receiving system 1a, and additionally has step C120. The steps of FIG. 7 identical in reference number with FIG. 5 designate the same steps as those carried out in the process in FIG. 5, so any repetitious description will be omitted here.

When the cash dispenser 30 receives the notification that the requested amount of cash can be paid to the client at the step D30 in FIG. 6, the cash dispenser 30 returns the card to the client (Step C70) and counts the bills stored in the bill storing section 307 until the counted bills reach the requested amount at Step c80′. The counted bills of the requested amount are transferred to the bill dispensing section 34 by the bill transferring section 306. After that, the cash dispenser 30 determines whether or not the cash transfer is completed normally (Step C100′).

For example, the cash dispenser 30 determines whether or not a problem arises in transferring bills by the bill transferring section 306. If it is determined that bill transfer is not completed normally (No route in Step C100′) due to a problem in transferring, the cash dispenser 30 completes the transaction by, for example, displaying occurrence of an abnormal transaction on the displaying/inputting section 31.

The client notifies the manager of the store of the occurrence of a problem based on an instruction that is displayed on the displaying/inputting section 31. At that time, since the cash being transferred in the cash dispenser 30 belongs to the manager, the manager has authority to deal with the problem.

When a problem does not arise during transferring the bills to a destination in the cash dispenser 30 (Yes route in Step C100′), the cash dispenser 30 notifies the relay center 20 that no problem has arisen (Step C110′).

Immediately before the cash dispenser 30 dispenses the permit-to-pay cash to the client, the relay center 20 causes the deposit managing section 10 to record a credit, of the same amount as the amount of cash to be dispensed to the client, to the store's account and a debit, of the same amount as the amount of the cash to be dispensed to the client, to the client's account (Steps D40 and D50 in FIG. 6).

Upon receipt of the completion of transaction of Steps D40 and D50 from the relay center 20, the cash dispenser 30 dispenses the cash by opening the cover plate of the cash dispensing section 34 or another operation so that the clients receive the bill (Step C120), whereupon the transaction is completed.

As mentioned above, the cash dispensing/receiving system 1b of the second embodiment guarantees the same advantageous result as the first embodiment. Additionally, since the deposit managing section 10 records the credit to the store's account and records the debit to the client's account immediately before the cash dispenser 30 dispenses the cash to the client, the cash in the cash dispenser 30 belongs to the manager until immediately before the cash dispenser 30 dispenses the cash to the client. Therefore, since if a problem arises while the permit-to-pay cash is dispensed to the client, the manager has authority to deal with the problem until immediately before the permit-to-pay cash is dispensed, the deposit managing section 10 would scarcely have to cancel the recorded credit and the recorded debit caused by the problem. As compared with the cash dispensing/receiving system 1a of the first embodiment, since the load on the deposit managing section 10 is relieved, reducing the number of times data communication performed in the cash dispensing/receiving system 1a and the quantity of data transmitted and received among the cash dispenser 30, the relay center 20 and the deposit managing section 10, it is possible to reduce the data traffic in the communication networks 40a and 40b.

(C) Third Embodiment:

A cash dispensing/receiving system 1c according to a third embodiment is identical in hardware with the cash dispensing/receiving system 1a of the first embodiment. In a cash dispensing/receiving system 1c, the cash dispenser 30 dispenses one or more bills to clients by a predetermined unit amount (e.g., 10,000 yen), as a different point from the first embodiment.

The predetermined unit amount can be arbitrarily set, and it is preferable to set the predetermined amount to 1,000 yen, 1,000 yen, 5,000 yen and 2,000 yen, which can be paid with one bill.

The deposit managing section 10 records a credit to the store's account and a debit to a client's account by the unit amount in which cash is dispensed to a client, in the illustrated embodiment.

Also in the third embodiment, the deposit managing section 10 records a credit to the store's account and a debit to a client's account immediately before the cash dispensing section 34 of the cash dispenser 30 dispenses permit-to-pay cash to a client, as with the second embodiment.

As an alternative, recording of a credit and a debit may be carried out immediately after the deposit managing section 10 checks the balance of a client's account as described in the first embodiment. Various changes or modifications of the manner of recording a credit and a debit may be suggested without departing from the concept of the invention.

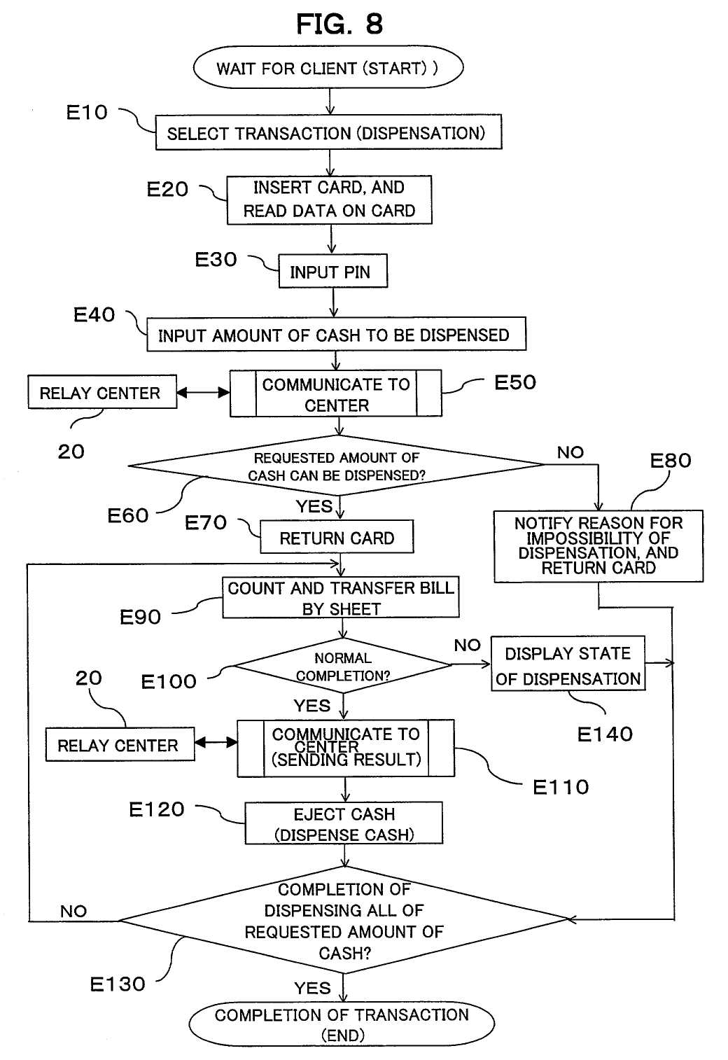

A succession of procedural steps (Steps E10 to E140) of dispensing cash performed by the cash dispenser 30 in the cash dispensing/receiving system 1c will now be described with reference to flow diagram FIG. 8.

When a client selects cash for payment on the displaying/inputting section 31 in the cash dispenser 30 (Step E10) and inserts a client's card to the card inserting section 32, the card reader 303 reads information (e.g., an account number) registered on the card (Step E20).

The client inputs the PIN (Step E30) and successively an amount of cash that the client requests for withdrawal (Step E40) using the displaying/inputting section 31 in accordance with instructions displayed on the displaying/inputting section 31.

The cash dispenser 30 communicates to the relay center 20 to send a telegram of payment request (Step E50) along with the information (the number of the client's account, the PIN, and the amount of cash requested for payment) obtained in Steps E20 to E40.

The cash dispenser 30 refers to the information sent from the relay center 20 (see Step D30 in FIG. 6) and determines whether or not the requested amount of cash can be paid to the client (Step E60). If the requested amount of cash cannot be paid (No route in Step E60), the reason is notified to the client on the displaying/inputting section 31, via a non-illustrated speaker or the like. Subsequently, the inserted card is returned to the client (Step E80) to complete the process.

On the other hand, if the requested amount of cash can be paid to the client (Yes route in Step E60), the cash dispenser 30 returns the inserted card to the client (Step E70), counts bills in the bill storing section 307 until the amount of counted bills reaches the requested amount, transfers the counted bills to the bill dispensing section 34 by the bill transferring section 306, and finally dispenses the bills from the bill dispensing section 34 by the unit amount (in the illustrated example, one bill) (Step E90).

The cash dispenser 30 determines whether or not the dispensing cash to the client has been normally completed (Step E100). For example, the cash dispenser 30 checks whether or not a problem, such as a transfer error in the bill transferring section 306, arises.

When no problem arises and the dispensation is normally completed (Yes route in Step E100), the cash dispenser 30 notifies the relay center 20 that no problem has arisen with the cash dispenser 30 (Step E110).

The relay center 20 causes the deposit managing section 10 to record a credit, of the same amount as the unit amount to be dispensed to the client from the cash dispenser 30, to the store's account and records a debit, of the same amount as the unit amount of the recorded credit, to the client's account (Steps D40 and D50 of FIG. 6) immediately before the cash dispenser 30 dispenses the permit-to-pay cash to the client. After that, upon receipt of notification of the completion of processes in Steps D40 and D50 from the relay center 20, the cash dispenser 30 dispenses one bill of the unit amount from the bill dispensing section 34 so that the client receives the permit-to-pay cash by the unit amount (Step E120).

Subsequently, the cash dispenser 30 calculates an amount of cash already paid to the client and determines whether or not the amount of cash paid is equal to the amount of cash that the client wishes to be paid (Step E130). When the amount of paid cash reaches the requested amount (Yes route in Step E130), the cash dispenser 30 completes the process. When the amount of paid cash does not reach the requested amount (No route in Step E130), the cash dispenser 30 returns the procedural steps to Step E90.

If transferring the bills is not completed normally (No route in Step E100) due to a somewhat problem in the bill transferring section 306, the cash dispenser 30 displays, on the displaying/inputting section 31, the amount of bills already dispensed to the client by the unit amount before the problem arose and notification that the cash dispensation has not been completed, along with the reason for the incomplete dispensation (Step E140).

The client notifies the manager of the incomplete dispensation based on an instruction on the displaying/inputting section 31. Since the cash in the cash dispenser 30 belongs to the manager while the permit-to-pay cash is transferred within the cash dispenser 30, the manager has authority to deal with the problem with the cash dispenser 30.

As mentioned above, the cash dispensing/receiving system 1c of the illustrated embodiment guarantees the same advantageous result as the second embodiment. Further, since the cash dispenser 30 dispenses the permit-to-pay cash to the client by the predetermined unit amount, it is possible to recognize the state of dispensing cash in the cash dispenser 30 with ease even if a problem arises, thereby improving reliance on the transaction.

(D) First Modification of the Cash Dispenser:

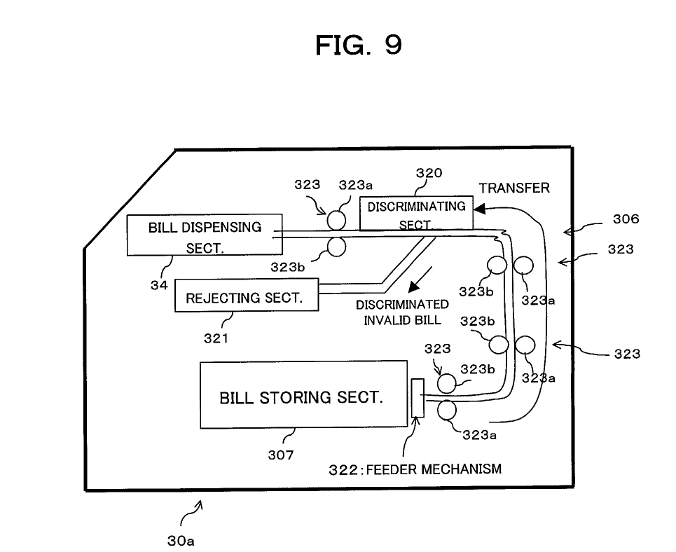

FIG. 9 schematically shows a first modification of the bill transferring section 306 of the cash dispenser 30 of the cash dispensing/receiving systems 1a, 1b, and 1c of the first through third embodiments.

In the cash dispenser 30a of the first modification, a bill storing section 307 stores bills (cash) currently belong to a manager of a site where the cash dispenser 30a is installed (hereinafter simply called the “manager”) as prospective permit-to-pay cash by fitting a non-illustrated case that contains the permit-to-pay cash to the bill storing section 307, likewise the cash dispenser 30 of the first embodiment.

The manner of loading the permit-to-pay cash into the cash dispenser 30a should by no means be limited to the above-mentioned manner. Alternatively, the cash dispenser 30a may be loaded with bills by inserting bills from a bill loading section (not shown in FIG. 2; e.g., a bill dispensing/receiving section 35 of FIG. 11) by individual bills or by predetermined bills, whereupon the inserted bills are transferred to the bill storing section 307 by the bill transferring section 306.

As shown in FIG. 9, the cash dispenser 30a comprises a discriminating section 320 and a rejecting section 321 that are included in the bill transferring section 306 of the first through third embodiments. The bill transferring section 306 further includes a feeder mechanism 322 for sending bills stored in the bill storing section 307 downstream by sheet, and one or more pairs 323 (four pairs appear in FIG. 9) of transferring rollers for transferring the bills sent to the bill dispensing section 34 by the feeder mechanism 322.

Two transfer rollers 323a and 323b, which constitute the pair 323 of the transferring rollers, are disposed so as to be opposed each other on both sides of the path for transferring bills. At least one of the transfer rollers 323a and 323b is driven by a non-illustrated motor so as to rotate, and, therefore, the transfer rollers 323a and 323b of the pair 323 co-operate to transfer bills to the bill dispensing section 34.

The discriminating section 320 is disposed on the transfer path of the bill transferring section 307 between the bill dispensing section 34 and the bill storing section 307, and discriminates whether or not the permit-to-pay cash in the cash dispenser 30a is valid. The discriminating section 320 discriminates whether or not bills that are transferred thereto from the bill storing section 307 by the bill transferring section 306 are valid by sheet when dispensing the bills to clients. If the discriminating section 320 discriminates a sheet of the bills is not valid (for example, a blank or the like, hereinafter called an error bill), the bill transferring section 306 transfers the error bill to the rejecting section 321, which stores error bills that have been discriminated to be invalid by the discriminating section 320. The error bills stored in the rejecting section 321 are removed by the manager. Conversely, bills that have been discriminated as valid by the discriminating section 320 are transferred to the bill dispensing section 34 by the bill transferring section 306.

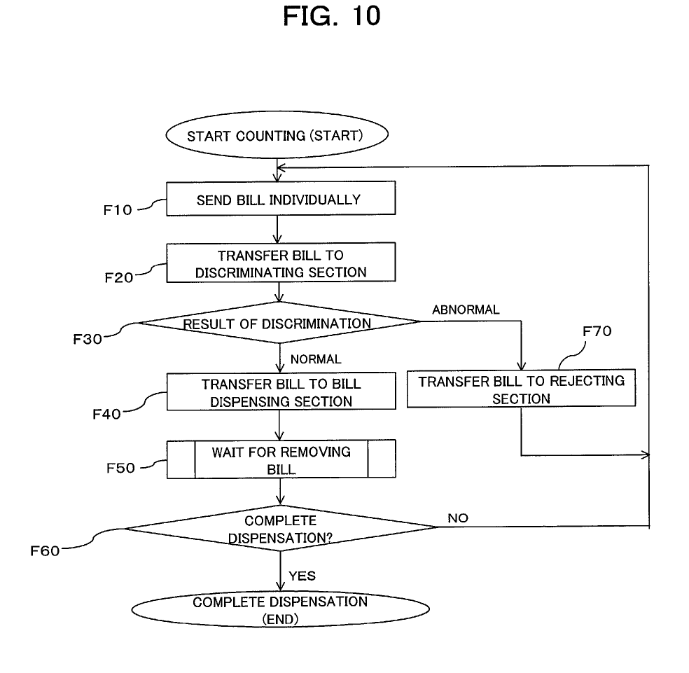

A succession of procedural steps (Steps F10 to F70) of dispensing cash in the cash dispenser 30a will now be described with reference to flow diagram FIG. 10.

When the bill counting/dispensing section 304 (see FIG. 1, omitted in FIG. 9) starts counting bills as they are dispensed to a client, the feeder mechanism 322 sends individual bills from the bill storing section 307 (Step F10), and the pairs 323 of the transferring rollers of the bill transferring section 306 transfer the sent bill to the discriminating section 320 (Step F20). The discriminating section 320 discriminates whether or not bills from the bill storing section 307 are valid individually (Step F30).

If the discriminating section 320 discriminates that a bill transferred thereto by the bill transferring section 306 is an error bill (“abnormal” route in Step F30), the error bill is transferred to the rejecting section 321 (Step F70) and the cash dispenser 30a returns the procedural step to Step F10. When the discriminating section 320 discriminates that a bill transferred thereto by the bill transferring section 306 is valid (“normal” route in Step F30), the bill transferring section 306 transfers the valid bill to the bill dispensing section 34 (Step F40) and the cash dispenser 30a waits for the client to take of the bill at the bill dispensing section 34 (Step F50).

After that, the cash dispenser 30a determines whether or not the dispensation is completed, in other words, whether or not the requested amount of bills has been dispensed to the client (Step F60). When the requested amount of bills has been dispensed (Yes route in Step F60), the cash dispenser 30a completes the transaction. However, if the requested amount of bills has not yet been dispensed (No route in Step F60), Step F10 is proceeded to in the cash dispenser 30a.

In the cash dispenser 30a, partly since the discriminating section 320 discriminates an error bill from valid bills among the bills stored in the bill storing section 307 if the bill storing section 307 stores an error bill, partly since the discriminated error bill is transferred to the rejecting section 321 to be isolated from the valid bills, it is possible to prevent an error bill from being issued to the client from the cash dispenser 30a and it is also possible to improve reliance on the transactions executed by the cash dispenser 30a.

In the cash dispensing/receiving system 1a, 1b, and 1c, since the cash dispenser 30 is installed at a site where a manager manages, and is loaded with cash (bills), which are currently belongs to the manager, as the prospective permit-to-pay cash (bills) there is a possibility that the cash loaded into the cash dispenser 30a by the manager includes an error bill; however, with the cash dispenser 30a of the first modification, an error bills can be prevented from being paid to a client thereby improving the reliance on the cash dispenser.

(E) Second Modification of the Cash Dispenser:

FIG. 11 schematically shows a second modification of the bill transferring section 306 of the cash dispenser 30 of the cash dispensing/receiving systems 1a, 1b, and 1c of the first through third embodiments.

The cash dispenser 30b of the second modification is substantially identical in configuration with the cash dispenser 30a of FIG. 9. As shown in FIG. 11, the cash dispenser 30b comprises a bill dispensing/receiving section 35, a discriminating section 320′, a rejecting section 321′, and a bill transferring section 306′ as substitutions for the bill dispensing section 34, the discriminating section 320, the rejecting section 321, and the bill transferring section 306 of the cash dispenser 30a, respectively. The identical reference numbers between FIGS. 9 and 11 designate identical or substantially identical parts or elements, so repetitious description is omitted here.

The bill dispensing/receiving section 35 dispenses bills to clients, and receives bills as the cash dispenser 30b is loaded with bills by the manager. The manager loads bills into the cash dispenser 30b from the bill dispensing/receiving section 35 individually or in predetermined amounts.

The bill transferring section 306′ transfers bills to a destination in the cash dispenser 30b. When loading bills into the cash dispenser 30b, the bill transferring section 306′ transfers a bill from the bill dispensing/receiving section 35 Where the bill is inserted, to the discriminating section 320′, where the bill is transfers the bill to the bill storing section 307. When dispensing a bill to a client, the bill transferring section 306′ transfers the bill stored in the bill storing section 307 to the bill dispensing/receiving section 35.

The discriminating section 320′ is disposed on the transferring path of the bill transferring section 306′ between the bill dispensing/receiving section 35 and the bill storing section 307 and discriminates whether or not the permit-to-pay cash (the permit-to-pay bills) loaded into the cash dispenser 30b is valid. The discriminating section 320′ discriminates whether or not bills that are transferred thereto from the bill dispensing/receiving section 35 by the bill transferring section 306′ are valid individually. If the discriminating section 320′ discriminates that a bill is an error bill, the bill transferring section 306′ transfers the error bill to the rejecting section 321′.

Conversely, a bill that has been discriminated as valid by the discriminating section 320′ is transferred to the bill storing section 307 by the bill transferring section 306′.

The rejection section 321′ stores error bills discriminated from the valid bills by the discriminating section 320′. The discriminated errors bill in the rejecting section 321′ are transferred to the bill dispensing/receiving section 35 to be returned to the manager after the inserted bills are transferred to the bill storing section 307 or the rejecting section 321′.

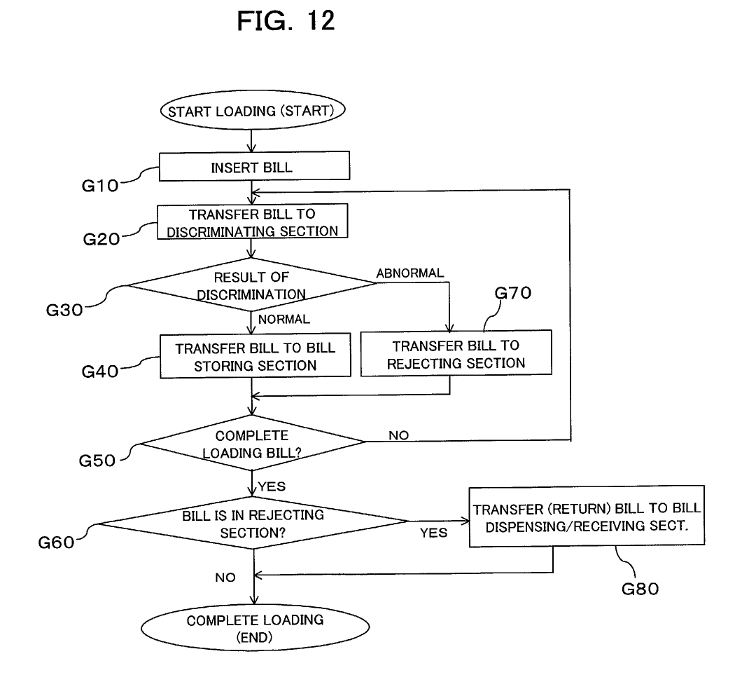

A succession of procedural steps (Steps G10 to G80) of loading bills into the cash dispenser 30b will now be described with reference to flow diagram FIG. 12.

When the manager loads one or more bills into the bill dispensing/receiving section 35 of the cash dispenser 30b (Step G10), the pairs 323 of the transferring rollers of the transferring section 306′ transfer the inserted bills to the discriminating section 320′ (Step G20). The discriminating section 320′ discriminates whether or not the bills transferred thereto from the bill dispensing/receiving section 35 are valid individually (Step G30).

If the discriminating section 320′ discriminates an inserted bill to be an error bill (“abnormal” route in Step G30), the error bill is transferred to the rejecting section 321′ (Step G70) whereupon Step G50 is proceeded to. On the other hand, the discriminating section 320′ discriminates that an inserted bill is valid (“normal” route in Step G30), the bill transferring section 306′ transfers the valid bill to the bill storing section 307 to store the bill (Step G40).

On the basis of the result of confirmation whether or not a bill is left at the bill dispensing/receiving section 35 or an instruction of completion of loading bills inputted by the manager from the displaying/inputting section 31, the cash dispenser 30b determines whether or not the loading of bills should be finished (Step G50) If the manager wishes to load more bills into the cash dispenser 30b (No route in Step G50), Step G10 is proceeded to.

When the loading of bills finishes (Yes route in Step G50), the cash dispenser 30b checks whether or not the rejecting section 321′ is storing any error bills (Step G60). If the rejecting section 321′ is storing one or more error bills (Yes route in Step G60), the error bills are returned to the manager by transferring the error bills to the bill dispensing/receiving section 35 (Step G80) to complete the process. When the rejection section 321 ′ stores no error bills (No route in Step G60) the cash dispenser 30b completes the process.

The cash dispenser 30b of the second modification guarantees the same advantageous result as the first modification. Additionally, since the discrimination of error bills from valid bills is performed when loading bills into the cash dispenser 30b, it is possible to prevent error bills from being stored in the cash dispenser 30b, thereby improving the reliance on the transaction performed by the cash dispenser 30b.

(F) Fourth Embodiment:

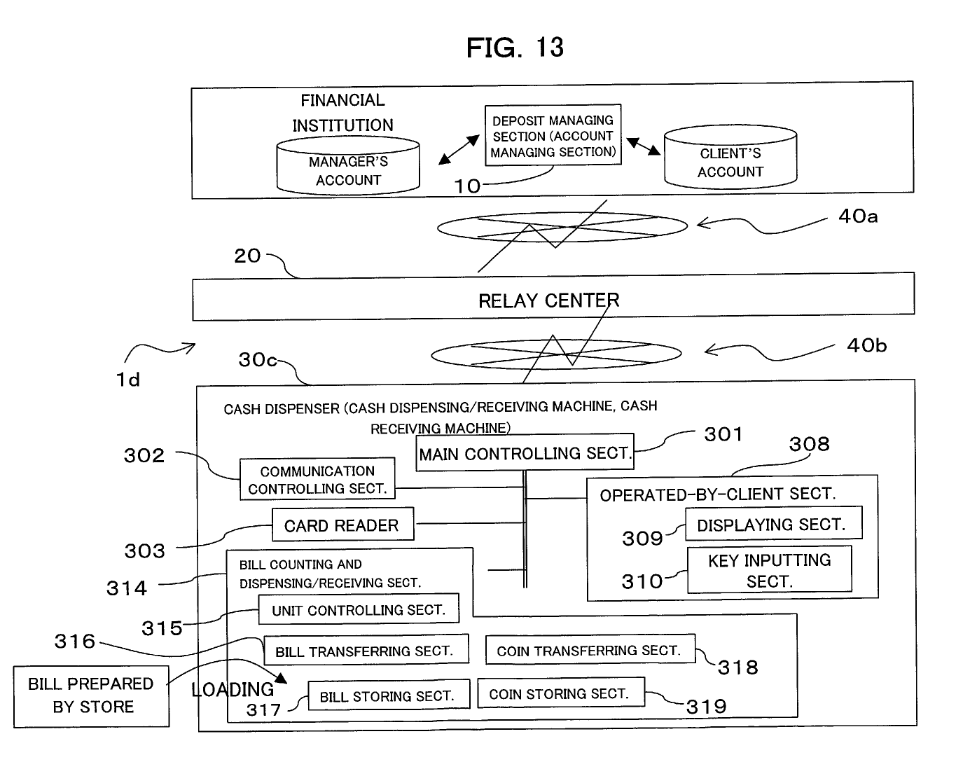

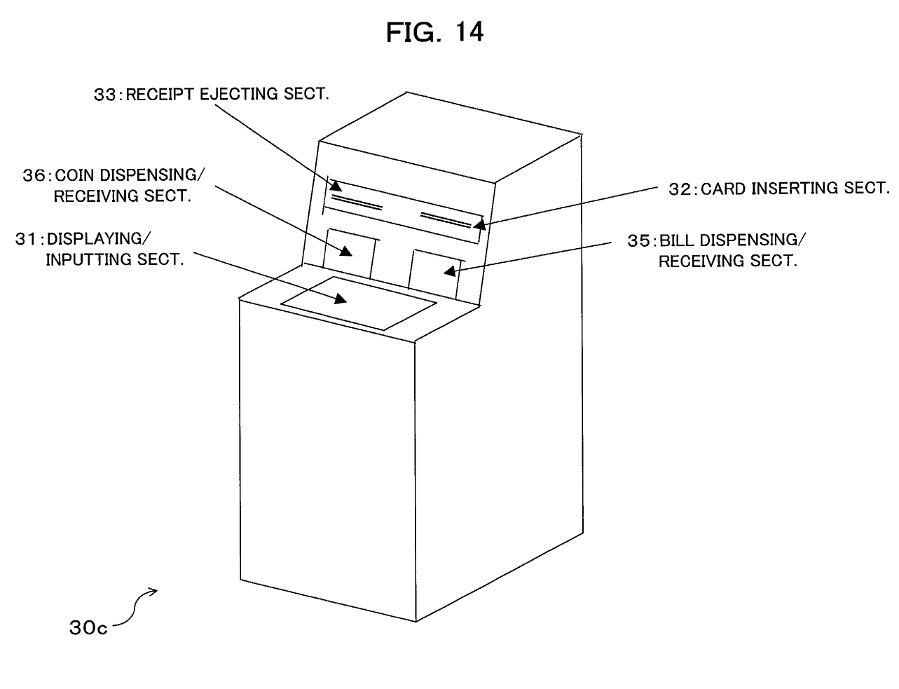

FIG. 13 schematically shows a cash dispensing/receiving system (a cash receiving system, a cash dispensing/receiving system) according to a fourth embodiment, and FIG. 14 is a perspective view showing a cash receiving machine (a cash dispensing/receiving machine) in the cash dispensing/receiving system of FIG. 13.

As shown in FIG. 13, the cash dispensing/receiving system 1d of the fourth embodiment comprises a cash dispensing/receiving machine 30c of FIG. 11 as a substitution for the cash dispenser 30 in the cash dispensing/receiving system 1a.

The cash dispensing/receiving machine 30c is installed in a retail store under contract with a financial institution, and, responding to a request from a client, dispenses cash (permit-to-pay cash) to the client or receives cash from the client. Therefore, the cash dispensing/receiving machine 30c serves to function to receive cash from clients along with the function as the cash dispenser 30 of FIGS. 1 and 2.

The process of dispensing cash from the cash dispenser id is identical with those performed in the cash dispensing/receiving system 1a, 1b and 1c of the first through third embodiments, so repetitious description is omitted here. In the illustrated embodiment, the process of receiving cash from a client will be described. The same reference numbers between the fourth and the foregoing embodiments designate identical or substantially identical parts or elements, so, again, repetitious description is omitted here.

As shown in FIG. 14, the cash dispensing/receiving machine 30c comprises the displaying/inputting section 31, the card inserting section 32, the receipt ejecting section 33, the bill dispensing/receiving section 35 and a coin dispensing/receiving section 36.

The bill dispensing/receiving section 35 dispenses, out of the cash dispensing/receiving machine 30c, the permit-to-pay cash (bill) transferred thereto by a bill transferring section 316 (See FIG. 13) and receives bills inserted by the manager or clients. For example, the bill dispensing/receiving section 35 includes a non-illustrated cover plate. The clients receive cash from the cash dispensing/receiving machine 30c, and the clients and the manger insert cash into the cash dispensing/receiving machine 30c by opening the cover plate.

The bill inserted into the cash dispensing/receiving machine 30c from the bill dispensing/receiving section 35 is transferred to the discriminating section 320′ (FIG. 11) by the bill transferring section 316. After discrimination by the discriminating section 320′, the inserted bill is transferred to a bill storing section 317. If the discriminating section 320′ discriminates that the inserted bill is an error bill, the error bill is transferred to the rejecting section 321′ (FIG. 11).

The coin dispensing/receiving section 36 dispenses coins (permit-to-pay cash) to be dispensed to clients transferred thereto by the coin transferring section 318 (FIG. 13) out of the cash dispensing/receiving machine 30c, and receives coins inserted into the cash dispensing/receiving machine 30c by clients. The coin dispensing/receiving section 36 includes a non-illustrated cover plate, and a client can receive coins from the cash dispensing/receiving machine 30c, and place coins in the cash dispensing/receiving machine 30c by opening the cover plate.

A coin from the coin dispensing/receiving section 36 is transferred to a non-illustrated coin discriminating section by the coin transferring section 318, which discriminates whether or not the inserted coin is valid. After the discrimination, the valid inserted coin is transferred to a coin storing section 319. If it is discriminated that the inserted coin is invalid, the inserted coin is transferred to the rejecting section 321′.

As shown in FIG. 13, the cash dispensing/receiving machine 30c comprises a bill counting and dispensing/receiving section 314 as a substitution for the bill counting/dispensing section 314 of the cash dispenser 30 of FIG. 1.

The bill counting and dispensing/receiving section 314 stores bills and coins, and dispenses/receives bills and coins as required. The bill counting and dispensing/receiving section 314 includes a unit controlling section 315, the bill transferring section 316, the bill storing section 317, the coin transferring section 318 and the coin storing section 319.

The bill storing section 317 stores bills loaded by the manager and bills inserted by clients. The bill transferring section 316 transfers bills to a destination in the cash dispensing/receiving machine 30c; when cash is paid to a client, the bill transferring section 316 transfers one or more bills to be paid to clients from the bill storing section 317 to the bill dispensing/receiving section 35; and, when cash is deposited by a client, the bill transferring section 316 transfers one or more inserted bills from the bill dispensing/receiving section 35 to the bill storing section 317.

The coin storing section 319 stores coins loaded by the manager and coins inserted by clients. The coin transferring section 318 transfers coins to a destination in the cash dispensing/receiving machine 30c; when cash is paid to a client, the coin transferring section 318 transfers one or more coins to be paid to the clients from the coins to ring section 319 to the coin dispensing/receiving section 36; and, when cash is inserted by a client, the coin transferring section 318 transfers one or more inserted coins from the coin dispensing/receiving section 36 to the coin storing section 319.

The unit controlling section 315 has overall control of the bill transferring section 316, the bill storing section 317, the coin transferring section 318 and the coin storing section 319.

When a client deposits cash into the cash dispensing/receiving machine 30c to record a credit to a client's account of the financial institution, the deposit managing section 10 of the fourth embodiment records a debit, of the same amount as the amount of cash received from the client, to the store's account, and records a credit, of the same amount as the amount of the cash received from the client, to the client's account (the destination account). The store's account may be possessed by the manager and may be possessed by the retail shop.

When a client intends to deposit cash in the destination account using the cash dispensing/receiving machine 30c, the deposit managing section 10 records a debit, of the same amount as the amount of the cash to be deposited by the client, to the store's account so that the cash deposited in the cash dispensing/receiving machine 30c by the client comes into property of the manager.

Since the recording the debit to the store's account is identical with moving a part of the store's account, the same amount as the amount of the cash deposited by the client, into the cash dispensing/receiving machine 30c from the store's account in the financial institution, the total value of the manager's assets does not change.

If the credit cannot be recorded in the client's account when the client deposits cash into the cash dispensing/receiving machine 30c (i.e., if a problem arises), the information about the cause (e.g., client's responsibility or store's responsibility) of the impossibility is notified to the client by displaying on the displaying/inputting section 31, via a non-illustrated speaker, outputting a receipt on which the cause is printed from the receipt ejecting section 33, or the like. Namely, the displaying/inputting section 31, the speaker, and the receipt ejecting section 33 respectively serve to function as a notifying section for notifying a client of a cause of the impossibility of recording a credit.

In the cash dispensing/receiving system 1d, the cause of the impossibility of recording a credit may be the responsibility of the client (e.g., no client's account exists, or the account is ineffectual), or may be the responsibility of another (e.g., the manager or the financial institution) than the client (e.g., the debit cannot be recorded to the store's account because the store's account is insufficient). When a credit cannot be recorded to the client's account, the information (the client or other than the client is responsible, or the cause of the impossibility) about the impossibility of the recording is displayed on the displaying/inputting section 31 so that the client can comprehend.

When, due to a problem arising with the cash dispensing/receiving machine 30c when receiving cash from a client, a debit cannot be recorded to the store's account or a credit cannot be recorded to the client's account, the deposit managing section 10 cancels the credit recorded to the client's account and the debit recorded to the store's account.

The manner of canceling the recorded debit to the store's account may be by canceling the recorded debit or by recording a credit, of the same amount as the amount of the debit, to the store's account. The manner of canceling the recorded credit to the client's account may be by canceling the recorded credit or by recording a debit, of the same amount as the amount of the recorded credit, to the client's account. After the cancellation operations, since the cash deposited into the cash dispensing/receiving machine 30c, which currently has belong to the manager, is returned belong to the client, the clients has authority to deal with the problem, for example by removing a jammed bill if a problem in transferring a bill arises.

If a credit is unsuccessfully recorded to the client's account (the transaction is failed), the deposit managing section 10 notifies the cash dispensing/receiving machine 30c of the cause (reason) of the impossibility.

Further, when the balance of the store's account becomes less than a predetermined amount, the deposit managing section 10 notifies the cash dispensing/receiving machine 30c of a shortfall in the balance of the store's account. Upon receipt of the notification, the cash dispensing/receiving machine 30c turns into a degeneracy operation mode by halting receipt of cash from clients. During the degeneracy operation mode, if the balance of the store's account regains an amount more than the predetermined amount due to recording credits to the store's account by paying cash to clients, the cash dispensing/receiving machine 30c discontinues the degeneracy operation mode and restarts receiving cash from the clients.

Also when the cash stored in the cash dispensing/receiving machine 30c becomes less than a predetermined amount, the cash dispensing/receiving machine 30c turns into a degeneracy operation mode by halting dispensing cash (payment) to clients. During the degeneracy operation mode, when clients deposit cash into the cash dispensing/receiving machine 30c to record credits to the destination account so that the cash stored in the cash dispensing/receiving machine 30c regains an amount more than the predetermined amount, the cash dispensing/receiving machine 30c discontinues the degeneracy operation mode and restarts dispensing cash to clients.

The relay center 20 relays communication between the deposit managing section 10 and the cash dispensing/receiving machine 30c, and causes the deposit managing section 10 to execute various processes in accordance with various transactions performed on the cash dispensing/receiving machine 30c. More specifically, upon receipt of a transaction telegram sent from the cash dispensing/receiving machine 30c, the relay center 20 performs relay operations, liaising with the deposit managing section 10.

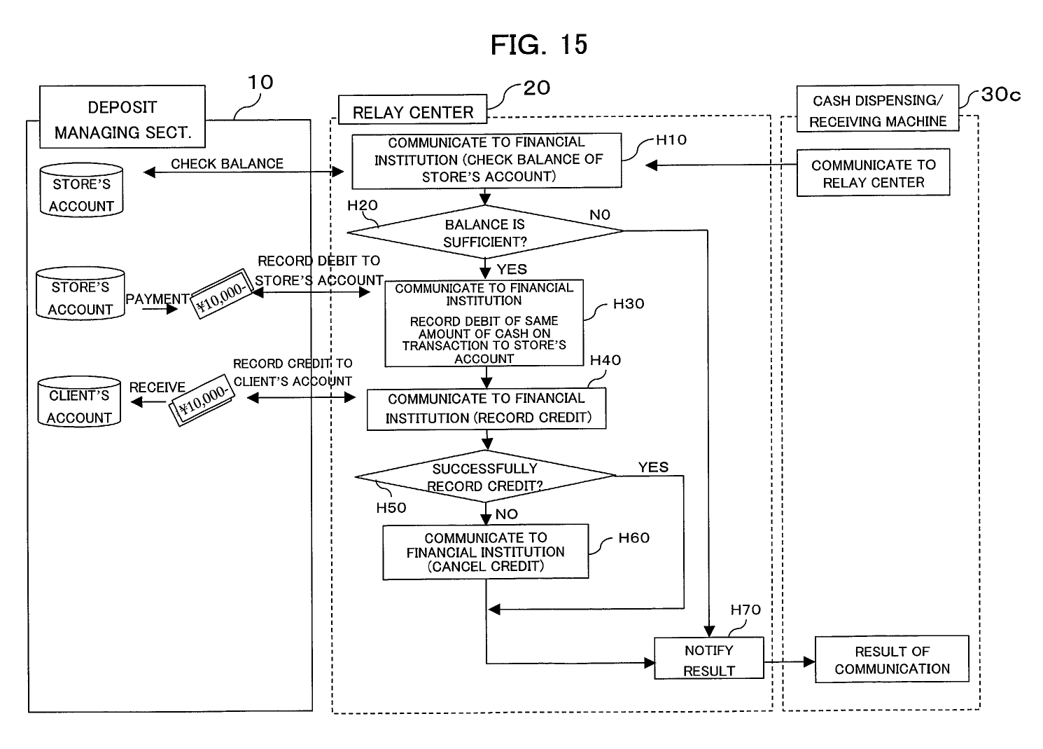

A succession of procedural steps (Steps H10 to H70) performed by the relay center 20 when receiving cash in the cash dispensing/receiving system id will now be described with reference to flow diagram FIG. 15.

When a client deposits cash into the cash dispensing/receiving machine 30c with a cash card or a passbook to record a credit to a destination account of the financial institution, the cash dispensing/receiving machine 30c discriminates the deposited cash in the discriminating section 320′ and communicates to the relay center 20. During the communication, the cash dispensing/receiving machine 30c sends the amount of the deposited cash, the number of the client's account, information to identify the cash dispensing/receiving machine 30c, information to identify the retail store (or the number of the store's account) and the like. The relay center 20 communicates to the deposit managing section 10 of the financial institution to request the deposit managing section 10 to check the balance of the store's account (Step H10). Responding to the request, the deposit managing section 10 checks the balance of the store's account and sends the result of the check to the relay center 20.

The relay center 20 determines whether the balance of the store's account becomes less than a predetermined amount if a debit, of the same amount as the amount of cash deposited by the client, is recorded to the store's account (Step H20). If the balance of the store's account becomes less than the predetermined amount after recording the debit (No route in Step H20), the relay center 20 notifies the cash dispensing/receiving machine 30c of the result of the determination (Step H70). In this case, the result of the determination is the impossibility of recording the debit to the store's account.

Conversely, if the balance of the store's account does not become less than the predetermined amount after recording the debit (Yes route in Step H20), the relay center 20 communicates to the deposit managing section 10 so as to cause the deposit managing section 10 to record a debit, of the same amount as the amount of the cash deposited by the client (the same amount of cash as in the transaction) to the store's account (Step H30). After recording the debit to the store's account, the cash deposited into the cash dispensing/receiving machine 30c by the client comes into property of the manager.

After that, the relay center 20 causes the deposit managing section 10 to record a credit of the same amount as an amount of cash deposited into the cash dispensing/receiving machine 30c by the client, to the client's account (Step H40) so that the balance of the client's account increases by the amount of the cash deposited into the cash dispensing/receiving machine 30c by the client.

The relay center 20 confirms whether the debit to the store's account and the credit to the client's account are successfully recorded (Step H50). For example, if the debit fails to be recorded to the store's account (No route in Step H50), the recorded debit canceled in the above-mentioned manner (Step H60) whereupon the process proceeds to Step H70 in which the relay center 20 notifies the cash dispensing/receiving machine 30c of the impossibility of recording the credit to the client's account due to successfully recording the debit to the store's account.

If the credit is unsuccessfully recorded to the client's account (No route in Step H50), the recorded credit is canceled in the above-mentioned manner (Step H60) whereupon the process proceeds to Step H70 in which the relay center 20 notifies the cash dispensing/receiving machine 30c that it is possible to record a credit to the client's account due to the credit to the client being unsuccessfully recorded.

When the credit is successfully recorded to the client's account (Yes route in Step H50), the procedural steps performed by the relay center 20 proceeds to Step H70 in which the relay center 20 notifies the cash dispensing/receiving machine 30c of the successfully recorded credit to the client's account. Responsive to the notification from the relay center 20, in the cash dispensing/receiving machine 30c, the bill transferring section 316 transfers the deposited bills to the bill storing section 317 to store the inserted bills in the bill storing section 317.

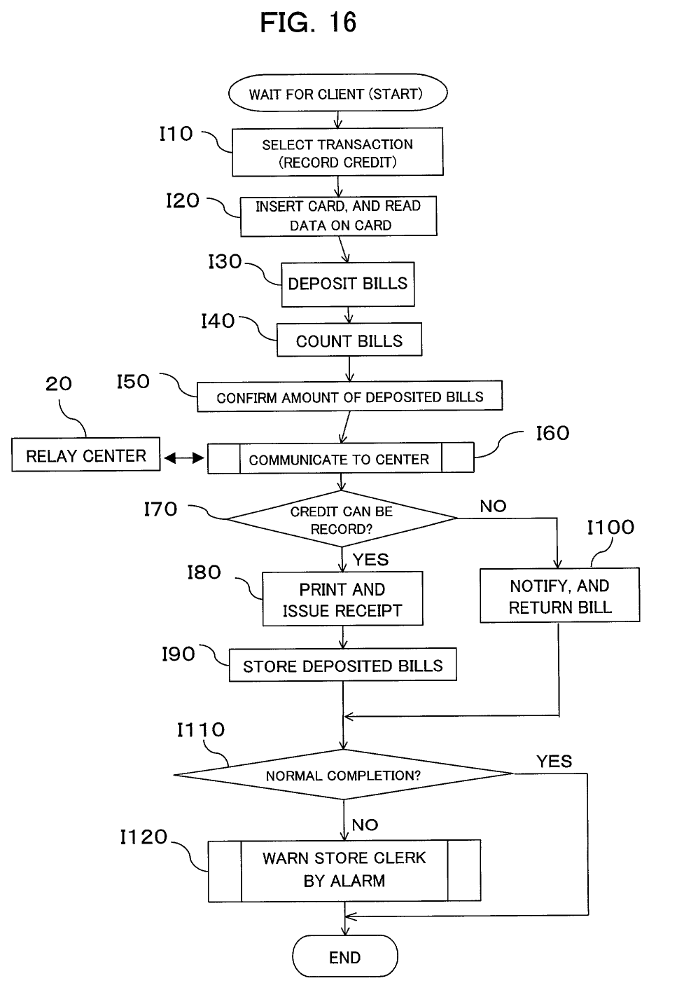

A succession of procedural steps (Steps I10 to I120) of receiving cash performed in the cash dispensing/receiving machine 30c will now be described with reference to flow diagram FIG. 16.

When a client selects deposit cash on the displaying/inputting section 31 in the cash dispensing/receiving machine 30c (Step I10) and inserts a client's card into the card inserting section 32, the card reader 303 reads information (e.g., an account number) registered on the card (Step I20).

The client inserts (deposits) one or more bills, of the same amount as the amount of cash that the client wishes to deposit into the client's account, to the bill inserting/receiving section 35 in accordance with instructions on the displaying/inputting section 31 (Step I30). The bill counting and dispensing/receiving section 314 of the cash dispensing/receiving machine 30c counts the deposited bills to obtain the amount of the deposited bills (Step I40) whereupon the discriminating section 320′ discriminates whether the deposited bills are valid. The cash dispensing/receiving machine 30c displays the amount of the counted bills on the displaying/receiving section 31 for confirmation by the client (Step I50).

The cash dispensing/receiving machine 30c communicates to the relay center 20 to send a telegram of a deposit request to identify the cash dispensing/receiving machine 30c (Step I60) along with the information (the number of the client's account, the amount of cash to be deposited, and the like) obtained in Steps I20 to I50.

The cash dispensing/receiving machine 30c refers to the information sent from the relay center 20 (see Step H70 in FIG. 15) and determines whether or not a debit, of the same amount as the requested amount of cash, can be recorded to the store's account (Step I70). If the debit can be recorded to the store's account (Yes route in Step I70), the cash dispensing/receiving machine 30c creates a receipt on which contents of the transaction is printed and ejects the receipt from the receipt ejecting section 33 (Step I80). After that, the bill transferring section 316 transfers the deposited bills to the bill storing section 317 to store the deposited bills in the bill storing section 317 (Step I90).

Subsequently, the cash dispensing/receiving machine 30c determines whether or not storing of the deposited bill has been successfully performed (Step I110). More specifically, the cash dispensing/receiving machine 30c determines whether or not a problem in transferring a bill to a destination in the cash dispensing/receiving machine 30c or the like has arisen; if storing of the deposited cash is unsuccessfully executed due to a problem that has arisen (No route in Step I110), the cash dispensing/receiving machine 30c notifies (warns) the client and the manger of occurrence of the problem using the displaying/inputting section 31 or a non-illustrated manager's display (Step I120) to complete the process. At that time, since all cash in the cash dispensing/receiving machine 30c belongs to the manager, the manager or an alternative to the manger has authority to remove a jammed bill or to perform other treatments in the cash dispensing/receiving machine 30c. On the other hand, if storing of the deposited cash can be normally performed (Yes route in Step I110), the cash dispensing/receiving machine 30c completes the process.

In the meanwhile, if it is determined that the credit, of the same amount as the amount of the deposited cash, cannot be recorded to the client's account (No route in Step I70), storing of the deposited bills in the cash dispensing/receiving machine 30c is canceled and the cause of the impossibility of the recording the credit is notified to the client and the manager on the displaying/inputting section 31 or by voice from the non-illustrated speaker. Further, the cash dispensing/receiving machine 30c counts the deposited bills and the bill transferring section 316 transfers the deposited bills to the bill dispensing/receiving section 35 to return the deposited bills to the client. The inserted card is also returned to the client (Step I100) whereupon Step I110 is proceeded to.

As mentioned above, the cash dispensing/receiving system 1d guarantees the same advantageous result as those of the foregoing embodiments. Further, since the deposit managing section 10 records a debit, of the same amount as the amount of cash of the credit recorded to the client's account, to the store's account, the cash deposited in the cash dispensing/receiving machine 30c by the client comes into the property of the manager after recording the debit. Therefore, it is possible for the manager or an alternative designated by the manager (e.g., a clerk in a retail store) to collect cash in the cash dispensing/receiving machine 30c or execute maintenance operations of the cash dispensing/receiving machine 30c.

Since, before the deposit managing section 10 records the debit to the store's account, the cash deposited into the cash dispensing/receiving machine 30c by the client still belongs to the client, it is possible for the manager or the alternative to collect cash in the cash dispensing/receiving machine 30c or execute maintenance operations with permission of the client.

As a result, if a problem arises in transferring bills to a destination in the cash dispensing/receiving machine 30c or the like when a client deposits cash to record a credit to a client's account, there is no requirement of requesting the financial institution or the agent to solve problems and of waiting for the financial institution or the agent to arrive at the installation site. For that reason, it is possible to improve the service to the clients or to enhance the convenience level for the clients and the manager. Further, since the manager or his/her alternative issue a reduced number of requests to the financial institution or the agent, it is possible to reduce the cost for the service charge to be paid to the financial institution or the agent.

If a problem arises when a client deposits cash to the cash dispenser into record a credit to their accounts of a financial institution, the deposit managing section 10 cancels the recorded credit to the client's account and the recorded debit to the store's account in the above-mentioned manners. Since, as a result of the cancellation, the cash deposited into the cash dispensing/receiving machine 30c by the client is returned to belong to the client, the manager deals with the problem with the cash dispenser with the permission of the client thereby improving the service to clients.

If a problem with transfer arises when receiving cash in the cash dispensing/receiving machine 30c, there is no requirement of requesting the financial institution or the agent to come to solve the problem, and of waiting for the financial institution or the agent. Therefore, it is possible to improve the convenience level for the clients and the manager, and to reduce the service charge to be paid to the financial institution or the agent due to a reduced number of requests to operate the cash dispensing/receiving machine 30c.

Partly because, if a credit is unsuccessfully recorded to a client's account, the cause of the unsuccessful recording, i.e., the client's responsibility or the store's responsibility, is notified to the client and the manager via the displaying/inputting section 31 or the non-illustrated speaker, and partly because the client and the manager can grasp the reasons for (contents of) the impossibility, it is possible to improve the convenience level for the clients and the manager.

(G) Others:

The present invention should by no means be limited to these foregoing embodiments and their modifications, and various changes or other modifications may be suggested without departing from the gist of the invention.

For example, in the first through third embodiments and their modifications, the cash dispensers 30, 30a, and 30b are loaded with the permit-to-pay cash and the loaded permit-to-pay cash is dispensed in bills to the clients as required; however the permit-to-pay cash should by no means be limited to bills. As an alternative, the permit-to-pay cash may be coins or alternatives to currencies, such as coupons.

Throughout the specification, the relay center 20 is communicably connected to the cash dispensers 30, 30a, and 30b and the cash dispensing/receiving machine 30c, and is communicably connected to deposit managing section 10. The communication carried out by the cash dispensing systems 1a through 1d should by no means be limited to those of the forgoing examples. Alternatively, the cash dispensers 30, 30a, and 30b, and the cash dispensing/receiving machine 30c may serve to function as the relay center 20 so as to execute the recording of credits and debits identical with those performed by the relay center 20 in the examples.

The cash dispensing systems 1a through 1c of the first through third embodiments and their modifications may comprise the cash dispensing/receiving machine 30c of the fourth embodiment as a substitution for the cash dispensers 30, 30a and 30b.

In the first modification, the cash dispenser 30c discriminates whether or not the permit-to-pay cash is valid when dispensing (paying) the permit-to-pay cash to clients. The discrimination should by no means be limited to when dispensing the permit-to-pay cash to clients. As an alternative, when loading cash into the cash dispenser 30a as the permit-to-pay cash, the permit-to-pay cash may be temporarily stored in the cash storing section 307 whereupon the bill transferring section 306 may transfer the bills in the bill storing section 307 to the discriminating section 320, which discriminates whether or not the transferred bills are valid. As a result of the discrimination, the bill transferring section 306 transfers only bills discriminated to be valid back to the bill storing section 307.

In the fourth embodiment, the cash dispensing/receiving machine 30c receives bills from a client that intends to record a credit to the client's account in a financial institution. The cash deposited by clients should by no means be limited to bills. As an alternative, clients may deposited coins or alternatives to currencies, such as coupons, into the cash dispensing/receiving machine 30c.

Further, in the fourth embodiment, clients may withdraw and deposit cash using the cash dispensing/receiving machine 30c. However, the cash dispensing/receiving system 1d should by no means be limited to comprise the cash dispensing/receiving machine 30c. As an alternative, the cash dispensing/receiving system 1d may comprise a cash receiving machine that only receives cash deposited by clients, as a substitution for the cash dispensing/receiving machine 30c.

Still further, in the fourth embodiment, a client deposits cash in the cash dispensing/receiving machine 30c to record a credit to the client's account, as a destination account, of a financial institution. However, a client should by no means be limited to depositing cash to record a credit to the client's account. As an alternative, the destination account may be an account other than the client's account (for example, an account of a credit card company).

What is claimed is:

1. A cash dispensing system comprising:
a cash dispenser, installed at a site where a manager manages said cash dispenser under contract with a financial institution, for dispensing cash to clients of the financial institution on their respective requests after said cash dispenser is loaded with cash, which currently belongs to the manager, as prospective permit-to-pay cash; and
an account managing section for managing client's accounts and a manager's account of the financial institution;
said account managing section being operable, before said cash dispenser dispenses said prospective permit-to-pay cash to the individual client, to record a credit, of the same amount as an amount of cash to be dispensed to the last-named individual client by said cash dispenser, to the manager's account of the financial institution.

2. A cash dispensing system according to claim 1, wherein said account managing section records a debit, of the same amount as the amount of the cash to be dispensed to the last-named individual client, from a source account.

3. A cash dispensing system according claim 1, wherein said account managing section records the credit immediately before said prospective permit-to-pay cash is ejected from said cash dispenser.

4. A cash dispensing system according claim 2, wherein said account managing section records the credit immediately before said prospective permit-to-pay cash is ejected from said cash dispenser.

5. A cash dispensing system according to claim 1, wherein, if a problem arises with said cash dispenser while said prospective permit-to-pay cash is being dispensed to the last-named individual client, said account managing section cancels the credit to the manager's account.

6. A cash dispensing system according to claim 2, wherein, if a problem arises with said cash dispenser while said prospective permit-to-pay cash is being dispensed to the last-named individual client, said account managing section cancels the credit to the manager's account.

7. A cash dispensing system according to claim 3, wherein, if a problem arises with said cash dispenser while said prospective permit-to-pay cash is being dispensed to the last-named individual client, said account managing section cancels the credit to the manager's account.

8. A cash dispensing system according to claim 4, wherein, if a problem arises with said cash dispenser while said prospective permit-to-pay cash is being dispensed to the last-named individual client, said account managing section cancels the credit to the manager's account.

9. A cash dispensing system according to claim 5, further comprising a notifying section for notifying, upon occurrence of the problem, at least information about the problem to the last-named individual client.

10. A cash dispensing system according to claim 6, further comprising a notifying section for notifying, upon occurrence of the problem, at least information about the problem to the last-named individual client.

11. A cash dispensing system according to claim 7, further comprising a notifying section for notifying, upon occurrence of the problem, at least information about the problem to the last-named individual client.

12. A cash dispensing system according to claim 8, further comprising a notifying section for notifying, upon occurrence of the problem, at least information about the problem to the last-named individual client.

13. A cash dispensing system according to claim 1, further comprising a discriminating section for discriminating whether or not said prospective permit-to-pay cash is valid.

14. A cash dispensing system according to claim 2, further comprising a discriminating section for discriminating whether or not said prospective permit-to-pay cash is valid.

15. A cash dispensing system according to claim 13, wherein, when said prospective permit-to-pay cash is dispensed to the last-named individual client, said discriminating section discriminates whether or not said prospective permit-to-pay cash is valid.

16. A cash dispensing system according to claim 14, wherein, when said prospective permit-to-pay cash is dispensed to the last-named individual client, said discriminating section discriminates whether or not said prospective permit-to-pay cash is valid.

17. A cash dispending system according to claim 13, wherein, when said cash dispenser is loaded with said prospective permit-to-pay cash, which currently belongs to the manager, said discriminating section discriminates whether or not the last-named cash is valid.

18. A cash dispending system according to claim 14, wherein, when said cash dispenser is loaded with said prospective permit-to-pay cash, which currently belongs to the manager, said discriminating section discriminates whether or not the last-named cash is valid.

19. A cash dispending system according to claim 1, wherein said cash dispenser dispends said prospective permit-to-pay cash by a predetermined unit amount.

20. A cash dispensing system according to claim 19, wherein said account managing section records the credit by said predetermined unit amount.

21. A method of dispensing cash to clients from a cash dispenser installed at a site where a manager manages the cash dispenser under contract with a financial institution, said method comprising the steps of:
(a) loading the cash dispenser with cash, which currently belongs to the manager, as prospective permit-to-pay cash;
(b) recording a credit, of the same amount as an amount of cash to be dispensed to an individual client of the financial institution by the cash dispenser, to the manager's account of the financial institution using an account managing section, of the financial institution, communicably connected with the cash dispenser; and
(c) dispensing said permit-to-pay cash, which is equivalent to the last-named amount of cash, to the last-named individual client.

22. A method of dispensing cash to clients from a cash dispenser according to claim 21, further comprising the step of recording a debit, of the same amount of the cash to be dispensed to the.

23. A method of dispensing cash to clients from a cash dispenser according to claim 21, wherein said credit is recorded immediately before said prospective permit-to-pay cash dispensing step (c).

24. A method of dispensing cash to clients from a cash dispenser according to claim 22, wherein said credit is recorded immediately before said prospective permit-to-pay cash dispensing step (c).

25. A method of dispensing cash to clients from a cash dispenser according to claim 21, further comprising the step of canceling said recording of said credit to the manager's account if a problem arises with the cash dispenser during said cash dispensing step (c).

26. A method of dispensing cash to clients from a cash dispenser according to claim 22, further comprising the step of canceling said recording of said credit to the manager's account if a problem arises with the cash dispenser during said cash dispensing step (c).

27. A method of dispensing cash to clients from a cash dispenser according to claim 23, further comprising the step of canceling said recording of said credit to the managers account if a problem arises with the cash dispenser during said cash dispensing step (c).

28. A method of dispensing cash to clients from a cash dispenser according to claim 24, further comprising the step of canceling said recording of said credit to the manager's account if a problem arises with the cash dispenser during said cash dispensing step (c).

29. A cash dispenser, adapted to be installed at a site where a manager manages the cash dispenser under contract with a financial institution, for dispensing cash to clients of the financial institution on their respective requests, wherein:
said cash dispenser is loaded with cash, which currently belongs to the manager, as prospective permit-to-pay cash; and
upon completion of recording a credit, of the same amount as an amount of cash to be dispensed to an individual client of the financial institution, to the manager's account of the financial institution,
said cash dispenser dispenses said prospective permit-to-pay cash, which is equivalent to the last-named amount of cash, to the last-named individual client.

30. A cash dispenser according to claim 29, further comprising a notifying section for notifying, if a problem arises with said cash dispenser while said prospective permit-to-pay cash is being dispensed to the last-named individual client, at least information about the problem to the last-named individual client.

31. A cash dispenser according to claim 29, further comprising a discriminating section for discriminating whether or not said prospective permit-to-pay cash is valid.

32. A cash dispenser according to claim 30, further comprising a discriminating section for discriminating whether or not said prospective permit-to-pay cash is valid.

33. A cash dispenser according to claim 31, wherein, when said cash dispenser dispenses said prospective permit-to-pay cash to the last-named individual client, said discriminating section discriminates whether or not said prospective permit-to-pay cash is valid.

34. A cash dispenser according to claim 32, wherein, when said cash dispenser dispenses said prospective permit-to-pay cash to the last-named individual client, said discriminating section discriminates whether or not said prospective permit-to-pay cash is valid.

35. A cash dispenser according to claim 31, wherein, when said cash dispenser is loaded with said prospective permit-to-pay cash, said discriminating section discriminates whether or not said prospective permit-to-pay cash is valid.

36. A cash dispenser according to claim 32, wherein, when said cash dispenser is loaded with said prospective permit-to-pay cash, said discriminating section discriminates whether or not said prospective permit-to-pay cash is valid.

37. A cash dispenser according to claim 29, wherein said prospective permit-to-pay cash is dispensed by a predetermined unit amount.

38. A cash dispenser according to claim 30, wherein said prospective permit-to-pay cash is dispensed by a predetermined unit amount.

39. A cash dispenser according to claim 31, wherein said prospective permit-to-pay cash is dispensed by a predetermined unit amount.

40. A cash dispenser according to claim 32, wherein said prospective permit-to-pay cash is dispensed by a predetermined unit amount.

41. A cash dispenser according to claim 33, wherein said prospective permit-to-pay cash is dispensed by a predetermined unit amount.

42. A cash dispenser according to claim 34, wherein said prospective permit-to-pay cash is dispensed by a predetermined unit amount.

43. A cash receiving system comprising:
a cash receiving machine, installed at a site where a manager manages said cash receiving machine under contract with a financial institution, for receiving cash from clients of the financial institution on their respective requests as prospective belong-to-manager cash; and
an account managing section for managing client's accounts and manager's account of the financial institution;
said account managing section being operable, when said cash receiving machine receives said prospective belong-to-manager cash from the individual client, to record a debit, of the same amount as an amount of cash received from the last-named individual client by said cash receiving machine, to the manager's account of the financial institution.

44. A cash receiving system according to claim 43, wherein said account managing section records a credit, of the same amount as an amount of cash received from the last-named individual client, to a destination account of the financial institution.

45. A cash receiving system according to claim 44, further comprising a notification section for notifying, if the debit is unsuccessfully recorded to the manager's account, information about a cause of the unsuccessful debit to the last-named individual client.

46. A cash receiving system according to claim 44, wherein, if the debit is unsuccessfully recorded to the manager's account, said account managing section cancels the debit and the credit.

47. A cash receiving system according to claim 45, wherein, if the debit is unsuccessfully recorded to the manager's account, said account managing section cancels the debit and the credit.

48. A cash receiving system according to claim 43, further comprising a discriminating section for discriminating whether or not said prospective belong-to-manager cash is valid.

49. A cash receiving system according to claim 44, further comprising a discriminating section for discriminating whether or not said prospective belong-to-manager cash is valid.

50. A cash receiving system according to claim 45, further comprising a discriminating section for discriminating whether or not said prospective belong-to-manager cash is valid.

51. A cash receiving system according to claim 46, further comprising a discriminating section for discriminating whether or not said prospective belong-to-manager cash is valid.

52. A cash receiving system according to claim 47, further comprising a discriminating section for discriminating whether or not said prospective belong-to-manager cash is valid.

53. A method of receiving cash from clients by a cash receiving machine installed at a site where a manager manages the cash receiving machine under contract with a financial institution, said method comprising the steps of:
(a) receiving cash from an individual client of the financial institution by the cash receiving machine as prospective belong-to-manager cash; and
(b) recording a debit, of the same amount as an amount of cash received from the last-named individual client, to the manager's account of the financial institution using an account managing section communicably connected with the cash receiving machine.

54. A method of receiving cash from clients by a cash receiving machine according to claim 53, further comprising the step of recording a credit, of the same amount as an amount of the cash received from the last-named individual client, to a destination account.

55. A method of receiving cash from clients by a cash receiving machine according to claim 54, further comprising the step of notifying, if said recording of said debit to the manager's account is failed in said receiving cash step (a), at least information about a cause of such failure of recording said debit to the last-named individual client.

56. A method of receiving cash from clients by a cash receiving machine according to claim 54, further comprising the step of canceling said recording of said credit to the destination account and said debit to the manager's account if said credit is unsuccessfully recorded to the destination account.

57. A method of receiving cash from clients by a cash receiving machine according to claim 55, further comprising the step of canceling said recording of said credit to the destination account and said debit to the manager's account if said credit is unsuccessfully recorded to the destination account.

58. A cash dispensing and receiving system comprising:
a cash dispensing/receiving machine, installed at a site where a manager manages said cash dispensing/receiving machine under contract with a financial institution, for dispensing cash to clients of the financial institution after said cash dispensing/receiving machine is loaded with cash, which currently belongs to the manager, as prospective permit-to-pay cash and for receiving cash from the clients as prospective belong-to-manager cash on their respective requests; and
an account managing section for managing clients' accounts and manager's account of the financial institution;
said account managing section being operable, before said cash dispensing/receiving machine dispenses said prospective permit-to-pay cash to the individual client, to record a credit, of the same amount as an amount of cash to be dispensed to the last-named individual client by said cash dispensing/receiving machine, to the manager's account of the financial institution; and
said account managing section being operable, when said cash dispensing/receiving machine receives said prospective belong-to-manager cash from the last-named individual client, to record a debit, of the same amount as an amount of cash received from the last-named individual client by said cash dispensing/receiving machine, to the manager's account of the financial institution.

59. A cash dispensing and receiving system comprising:
a cash dispenser, installed at a site where a first manager manages said cash dispenser under contract with a financial institution, for dispensing cash to clients of the financial institution on their respective requests after said cash dispenser is loaded with cash, which currently belongs to the manager, as prospective permit-to-pay cash;
a cash receiving machine, installed at a site where a second manager manages said cash receiving machine under contract with the financial institution, for receiving cash from the clients as prospective belong-to-manager cash on their respective requests; and
an account managing section for managing clients' accounts, first manager's account and second manager's account of the financial institution;
said account managing section being operable, before said cash dispenser dispenses said prospective permit-to-pay cash to the individual client, to record a credit, of the same amount as an amount of cash to be dispensed to the last-named individual client by said cash dispensing/receiving machine, to the first manager's account of the financial institution; and
said account managing section being operable, when said cash receiving machine receives said prospective belong-to-manager cash from the last-named individual client, to record a debit, of the same amount as an amount of cash received from the last-named individual client by said cash receiving machine, to the second manager's account of the financial institution.
